(19) United States
(12) Patent Application Publication
(10) Pub. No.: US 2025/0188096 A1
(43) Pub. Date: Jun. 12, 2025

(54) BENT OXAZOLE-BASED ORGANIC LINKERS FOR THE RETICULAR FORMATION OF METAL-ORGANIC FRAMEWORKS AND METHODS OF PREPARATION THEREOF

(71) Applicant: KING FAHD UNIVERSITY OF PETROLEUM AND MINERALS, Dhahran (SA)

(72) Inventors: Mahmoud Mohamed Mohamed ABDELNABY, Dhahran (SA); Ahmed Mohamed Abdelazim ALLOUSH, Damanhour (EG)

(73) Assignee: KING FAHD UNIVERSITY OF PETROLEUM AND MINERALS, Dhahran (SA)

(21) Appl. No.: 18/537,110

(22) Filed: Dec. 12, 2023

(51) Int. Cl. C07F 3/06; B01J 23/44; C01B 39/00

(52) U.S. Cl. CPC C07F 3/06; B01J 23/44; C01B 39/00

(57) ABSTRACT

A metal-organic framework (MOF) includes one or more metal ions and one or more oxazole-based organic linkers. Each of the one or more oxazole-based organic linkers includes an oxazole core substituted with two or more substituted aromatic rings. The one or more metal ions are linked to the one or more oxazole-based organic linkers through a nitrogen atom of the oxazole core. The MOF has a cross-linked porous reticular structure containing a plurality of extended tripodal and polyhedral units. The MOF is in the form of particles having a particle size in the longest dimension of 5 to 40 μm.

### BACKGROUND

### Technical Field

The present disclosure is directed to a metal-organic framework (MOF), particularly, to a MOF including metal ions and oxazole-based organic linkers.

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Reticular synthesis, often referred to as reticular chemistry, is the process of assembling pre-designed rigid molecular building blocks into extended, stable, and ordered frameworks. The building units of these extended structures are held together with strong and stable bonds, and this is the main feature that sets them apart from supramolecular assembly-based materials. Furthermore, the structural rigidity and integrity of the building units do not change during framework formation, distinguishing reticular synthesis from the retrosynthesis of organic compounds. Metal-organic frameworks (MOFs) are a major category of materials within the field of reticular chemistry. MOFs are constructed from two different types of building units: (i) inorganic polynuclear oxo-clusters; and (ii) rigid organic linkers functionalized with chelating sites from which the marriage between the inorganic and organic precursors occur to create open ordered frameworks with permanent porosity. These components can only be connected in an alternating fashion to form the framework, and they are also referred to as secondary building units (SBUs) that can be designed, synthesized, or modified independently.

A wide range of 2D and 3D structures, each possessing diverse overall structures and properties, has been developed. MOFs have become one of the effective approaches to the synthesis and production of porous materials. The flexibility in modifying both SBUs and organic linkers, coupled with the capability of functionalizing and designing the pores of the material, has enabled the preparation of thousands of unique compounds. Exemplary MOFs can be found in

FIG. 1. MOFs have become an integral element in a wide spectrum of applications across various fields, such as gas storage and separation, charge storage materials, electro- and chemical catalysis, and sensing applications. Therefore, crafting organic linkers with tailored properties is of utmost importance in creating a new MOF material that can stand out amid the existing library of materials.

The creation of extended structures consisting of organic compounds, known as ligands or linkers, which coordinate with metallic centers to create coordination networks has roots dating back to the 1950s. A copper (I) metal with nitrate anions serving as counter ions was coordinated to the cationic network of organic nitriles [Y. Kinoshita, I. Matsubara, T. Higuchi, and Y. Saito, “The Crystal Structure of Bis(adiponitrilo) copper (I) Nitrate,” BCSJ, vol. 32, no. 11, pp. 1221-1226, 1959]. The coordination networks of this material were pre-designed based on the knowledge of the predetermined geometries of both the organic and inorganic constituents. Although these networks introduced a new level of synthetic control over the topology of the final extended structure, they had some major drawbacks. All of the networks reported were formed through an electron donation from a neutral nitrogen atom within the organic linker (e.g., nitrile nitrogen or pyridinic nitrogen) to the metal center. This rather weak interaction responsible for holding the network together, along with the formation of a positively charged network, resulted in an overall loss in structural, thermal, and chemical stability for the material. Also, the formed networks were interpenetrated (i.e., two or more networks formed, either completely or partially, with interlaced parts only mechanically locked without any chemical bond formation between the networks. The interlaced parts cannot be separated without bond cleavage), and their internal pores were occupied by the network counter ions and inaccessible by any potential guest molecules.

A framework that utilized a charged organic linker, such as 1,3,5-benzene tricarboxylic acid (BTC), to bind with cobalt (III) ions in the presence of pyridine molecules coordinating to the cobalt open metal sites. The resulting framework was characterized by the chemical formula CoC₆H₃(COOH_{1/3})₃·(NC₅H₅)₂·2/3NC₅H₅ that can be described as alternating layers of Co(BTC) and pyridine forming a layered framework called MOF-1 [O. M. Yaghi, G. Li, and H. Li, “Selective binding and removal of guests in a microporous metal-organic framework,” Nature, vol. 378, no. 6558, pp. 703-706, 1995]. The implementation of a charged organic linker informing the network had an impact in overcoming the drawbacks of the previously developed coordination networks through the following aspects: (i) the formal charge on the carboxylate anions formed a much stronger bond with the cobalt cation compared to just coordinating with a neutral nitrogen atom; (ii) neutralizing the positive charge on the metal resulting in an overall neutral framework, instead of a cationic one, with higher chemical stability; and (iii) by omitting the need for a counter ion, the internal pore space became much more accessible for guest molecules as proven by the selective binding and removal of pyridine molecules with thermal swings.

A 3D framework, MOF-5 as depicted in FIG. 5, with improved porosity and surface area was developed [H. Li, M. Eddaoudi, M. O'Keeffe, and O. M. Yaghi, “Design and synthesis of an exceptionally stable and highly porous metal-organic framework,” Nature, vol. 402, no. 6759, pp. 276-279, 1999]. The high surface area came as a result of high mechanical stability, which allowed the framework to stay intact under harsh vacuum conditions without collapsing upon the removal of guest molecules. These attributes stemmed from the usage of a metal cluster or a secondary building unit (SBU). The Zn₄O(COO)₆ showed that using a multinuclear metallic oxo-cluster and the charged organic linkers are the key factors for creating robust MOF structures.

HKUST-1 as shown in FIG. 3 is a MOF developed by Williams et al. [S. S.-Y. Chui, S. M.-F. Lo, J. P. H. Charmant, A. G. Orpen, and I. D. Williams, “A Chemically Functionalizable Nanoporous Material [Cu₃(TMA)₂(H₂O)₃]ₙ” Science, vol. 283, pp. 1148-1150, 1999]. The 3D framework of HKUST-1 was constructed by a paddle-wheel cluster of copper, Cu₂(COO)₄(H₂O)₂, and 1,3,5-benzene tricarboxylic acid (BTC). In some instances, copper may be replaced with zinc as an SBU to form the MOF-2. As 1,4-benzene dicarboxylic acid (BDC) was used as the organic linker, the formed MOF-2 was a 2D framework with sql topology. In the case of HKUST-1, as BTC was used, the extra carboxylate group provided an opportunity for the framework to grow in the three-dimensional space giving rise to a tbo net with completely different structural properties.

Late-transition metals (e.g., zinc, copper, nickel, and cobalt) were explored in the realm of MOFs. However, some concerns regarding their chemical stability were reported. Many of the MOFs reported struggled to maintain crystallinity after prolonged exposure to aqueous solutions or a wide range of basic or acidic pH environments. The marriage between the SBUs in MOFs is merely a metal-oxygen bond, and apart from any other factors such as framework density, and mechanical integrity due to topology or linker length, a significant portion of the framework stability can be attributed to the strength of that metal-oxygen bond. In the periodic table of elements and within transition metals, metal-oxygen bond dissociation energies (BDE) show an overall linear decline trend going from left to right [K. A. Moltved and K. P. Kepp, “The chemical bond between transition metals and Oxygen: Electronegativity, d-Orbital Effects, and Oxophilicity as Descriptors of Metal-Oxygen Interactions,” Journal of Physical Chemistry C, vol. 123, no. 30, pp. 18432-18444, 2019]. Early transition metals, with their higher acidity and fewer electrons, can have oxygen's lone pair of electrons donating to their vacant d-orbitals, thus strengthening the metal-oxygen bond. However, a study showed that the primary factor contributing to the difference in BDEs between oxygen-early transition metal bonds (e.g., Ti—O=667±6 kJ mol⁻¹; Zr—O=766±11 kJ mol⁻¹), and oxygen-late transition metal bonds (e.g., Cu—O=287=12 kJ mol⁻¹; Zn—O=159±4 KJ mol⁻¹) is the decrease in polar covalent bond character. As the electronegativity of the metals increases going from left to right down a period, the difference in electronegativity between the metal and oxygen decreases, resulting in a weaker bond. This shows that MOFs created with early transition metals may possess a chemically stable framework. UiO-66 contains a metal oxo-cluster with the formula Zr₆O₄(OH)₄(COO)₁₂ as depicted in FIG. 5 [J. H. Cavka et al., “A new zirconium inorganic building brick forming metal-organic frameworks with exceptional stability,” J Am Chem Soc, vol. 130, no. 42, pp. 13850-13851, 2008]. This Hexa-nuclear cluster played a crucial role in enhancing the chemical stability of the framework. Additionally, the use of the BDC linker, employed in several other MOFs, further contributed to its robustness. Two other iso-reticular structures of UiO-66, such as UiO-67, and UiO-68, were synthesized. The term iso-reticular is used to describe frameworks with the same topology or connectivity but having extended organic linkers, usually through the addition of more benzene rings (e.g., UiO-66 with BDC; UiO-67 with BPDC; UiO-68 with TPDC). As the importance of the UiO-66 framework grew more pronounced, efforts were made to streamline its synthesis for potential industrial applications. A room temperature synthesis of UiO-66 and its derivatives is reported.

One of the most important characteristics of porous materials is their surface area, and MOFs have provided researchers with tools that allow them to reach increased peak values of surface area in the realm of porous structures. High surface areas reflect higher accessibility to the materials' surfaces and their exposure to any potential guest molecules. Such property is essential to achieve high efficiency in applications such as catalysis, in which every single active site within the catalyst needs to be accessible and functional in order to use the least amount possible of the catalyst and realize the maximum theoretical performance possible. The linkers of NU-109E and NU-110E were designed as extended tripodal units that end with hexa-carboxylate groups [O. K. Farha et al., “Metal-organic framework materials with ultrahigh surface areas: Is the sky the limit?” J Am Chem Soc, vol. 134, no. 36, pp. 15016-15021, 2012]. Instead of employing benzene rings, acetylene groups were used to extend the linker arms, as they proved to be more area-efficient in facilitating edge exposure and adsorption sites. Additionally, acetylene groups, with their lower molar mass compared to phenylenes, resulting in a higher gravimetric surface area. Another example is DUT-60, which has a new record high surface area as depicted in FIG. 5 [I. M. Hönicke et al., “Balancing Mechanical Stability and Ultrahigh Porosity in Crystalline Framework Materials,” Angewandte Chemie-International Edition, vol. 57, no. 42, pp. 13780-13783, 2018].

Metal-catecholates or CATs, such as Cu-CAT-1, Ni-CAT-1, and Co-CAT-1, are reported [M. Hmadeh et al., “New porous crystals of extended metal-catecholates,” Chemistry of Materials, vol. 24, no. 18, pp. 35 11-3513, 2012]. The usage of a new binding mode through two adjacent hydroxy groups, as found in catechol, 1,2-dihydroxybenzene, provided a robust framework of chemically connected 2D sheets stacked together through π-π interaction to provide a material with 1D hollow channels within it. Cu-CAT-1 showed a higher conductivity value compared to other MOFs and opened the door for exploring and investigating the conductivity within MOF materials.

It is believed that MOFs have demonstrated their potential as porous materials that are capable of enhancing a diverse array of chemical and physical properties within the scope of extended porous structures. Although several MOFs have been developed in the past, there still exists a need to develop new MOFs that bring forth improved properties.

In view of the foregoing, it is one objective of the present disclosure to provide a metal-organic framework (MOF) that contains an oxazole-based organic linker. A second objective of the present disclosure is to provide a method of making the MOF.

### SUMMARY

In an exemplary embodiment, a metal-organic framework (MOF) is described. The MOF includes one or more metal ions; and one or more oxazole-based organic linkers. In some embodiments, each of the one or more oxazole-based organic linkers comprises an oxazole core substituted with two or more substituted aromatic rings. In some embodiments, the one or more metal ions are linked to the one or more oxazole-based organic linkers through a nitrogen atom of the oxazole core. In some embodiments, the MOF has a cross-linked porous reticular structure including a plurality of extended tripodal and polyhedral units. In some embodiments, the MOF is in the form of particles having a particle size in a longest dimension of 5 to 40 micrometers (μm).

In some embodiments, the MOF has a diamondoid framework comprising the one or more metal ions bridged by the one or more of the oxazole-based organic linkers.

In some embodiments, the one or more metal ions are selected from the group consisting of zirconium, zinc, titanium, copper, nickel, cobalt, and iron.

In some embodiments, the one or more oxazole-based organic linkers are selected from the group consisting of 2,5-bis(4-carboxyphenyl)oxazole of formula (I), 2,5-bis(4-(1H-tetrazole-5-yl)phenyl)oxazole of formula (II), and 2,5-bis(4-carboxybiphenyl-4′-yl)oxazole of formula (III);

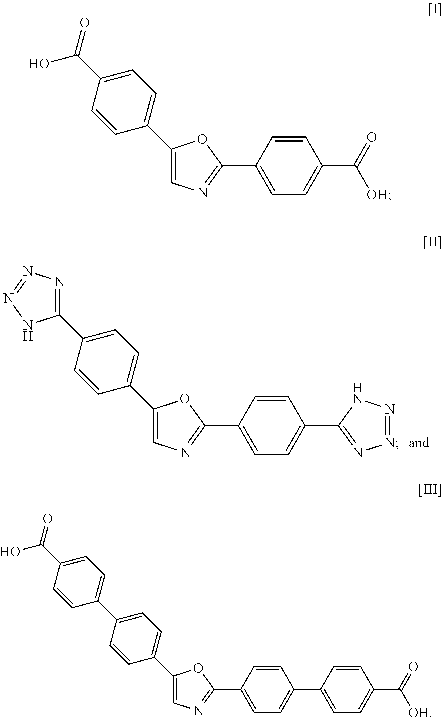 [SMILES: O=C(O)c1ccc(-c2cnc(-c3ccc(C(=O)O)cc3)o2)cc1 ; c1cc(-c2cnc(-c3ccc(-c4nnn[nH]4)cc3)o2)ccc1-c1nnn[nH]1 ; "and" ; O=C(O)c1ccc(-c2ccc(-c3cnc(-c4ccc(-c5ccc(C(=O)O)cc5)cc4)o3)cc2)cc1]

In some embodiments, the two or more substituted aromatic rings define planes that are substantially parallel with each other.

In another exemplary embodiment, a method of making the MOFs described. The method includes mixing and dissolving an oxazole-based organic linker in dimethylformamide (DMF) to form a solution; mixing a metal precursor, a monocarboxylate acid, and the solution to form a mixture; heating the mixture to form a precipitate; and separating the precipitate from the mixture, washing, and drying to form the MOF.

In some embodiments, the metal precursor is at least one selected from the group consisting of a zirconium salt, a zinc salt, a titanium salt, a copper salt, a nickel salt, a cobalt salt, and an iron salt.

In some embodiments, the monocarboxylate acid is acetic acid.

In some embodiments, the metal precursor is present in the mixture at a concentration in a range of 0.05-0.5 molar (M).

In some embodiments, a molar ratio of the metal precursor to the oxazole-based organic linker in the mixture is in the range of 5:1 to 1:5.

In some embodiments, the method further includes preparing the oxazole-based organic linker by nitrating 2,5-diphenyloxazole in the presence of sulfuric acid and nitric acid to produce a nitrated crude product; and purifying the nitrated crude product by recrystallizing to form a 2,5-bis(4-nitrophenyl)oxazole of formula (IV). The method further includes reducing the 2,5-bis(4-nitrophenyl)oxazole in the presence of a first palladium catalyst and a hydrogen gas to produce a 2,5-bis(4-aminophenyl)oxazole of formula (V); iodinating the 2,5-bis(4-aminophenyl)oxazole in the presence of a nitrite salt, and an iodide salt to produce a 2,5-bis(4-iodophenyl)oxazole of formula (VI); and cyaniding the 2,5-bis(4-iodophenyl)oxazole in the presence of a cyanide salt to produce a 2,5-bis(4-cyanophenyl)oxazole of formula (VII).

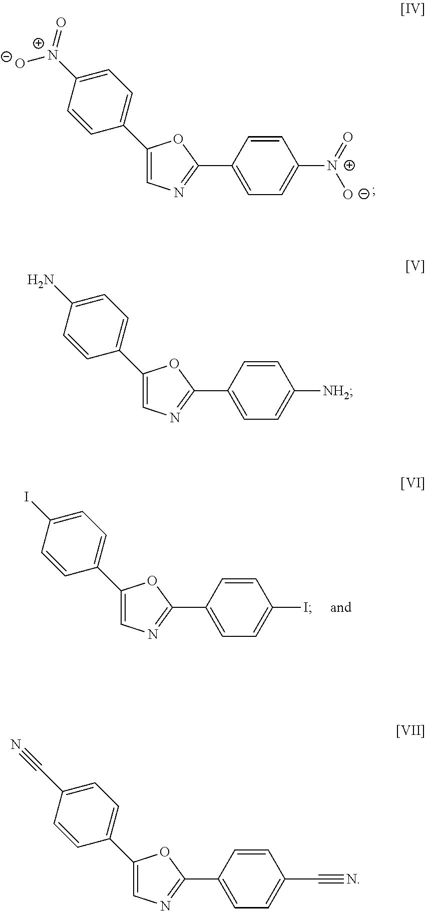 [SMILES: O=[N+]([O-])c1ccc(-c2cnc(-c3ccc([N+](=O)[O-])cc3)o2)cc1 ; Nc1ccc(-c2cnc(-c3ccc(N)cc3)o2)cc1 ; Ic1ccc(-c2cnc(-c3ccc(I)cc3)o2)cc1 ; N#Cc1ccc(-c2cnc(-c3ccc(C#N)cc3)o2)cc1]

In some embodiments, the first palladium catalyst is a palladium/carbon catalyst having a palladium concentration of about 5 wt. % based on a total weight of the palladium/carbon catalyst.

In some embodiments, the nitrite salt is at least one selected from the group consisting of sodium nitrite, and potassium nitrite.

In some embodiments, the method further includes preparing the 2,5-bis(4-carboxyphenyl)oxazole of formula by hydrolyzing the 2,5-bis(4-cyanophenyl)oxazole in the presence of a base at a temperature of about 90 to 100° C.

In some embodiments, the base is at least one selected from the group consisting of lithium hydroxide, sodium hydroxide, potassium hydroxide, and calcium hydroxide.

In some embodiments, the method further includes preparing the 2,5-bis(4-(1H-tetrazole-5-yl)phenyl)oxazole of formula (II) by: reacting the 2,5-bis(4-cyanophenyl)oxazole and an azide compound in the presence of an indium salt by a cycloaddition reaction at a temperature of about 130 to 150° C.

In some embodiments, the azide compound is at least one selected from the group consisting of sodium azide, potassium azide, and calcium azide.

In some embodiments, the method further includes preparing the 2,5-bis(4-carboxybiphenyl-4′-yl)oxazole of formula by: reacting the 2,5-bis(4-iodophenyl)oxazole in the presence of a second palladium salt and an arylboronic acid via a Suzuki cross-coupling reaction to produce a 2,5-bis(4-carboxybiphenyl methyl ester 4′-yl)oxazole of formula (VIII); and hydrolyzing the 2,5-bis(4-carboxybiphenyl methyl ester 4′-yl)oxazole in the presence of a base at a temperature of about 50 to 90° C.

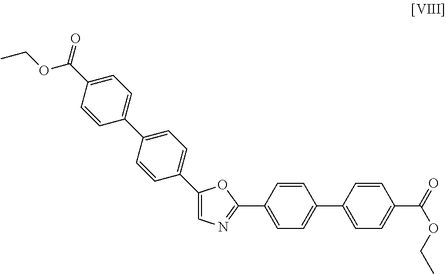 [SMILES: CCOC(=O)c1ccc(-c2ccc(-c3cnc(-c4ccc(-c5ccc(C(=O)OCC)cc5)cc4)o3)cc2)cc1]

In some embodiments, the second palladium salt is palladium acetate having a palladium concentration of about 45 to 50 wt. % based on a total weight of the palladium acetate. In some embodiments, the arylboronic acid is 4-ethoxycarbonylphenylboronic acid.

In some embodiments, the metal precursor includes a zinc salt, wherein the MOF has peaks with a 2-theta value of 5 to 6°, and 6.5 to 9.5°, as determined by powder X-ray diffraction (PXRD) spectrum.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 shows an example of certain secondary building units (SBUs) having various metals with varying oxidation states, geometries, and overall cluster geometry with respect to the extension point of the linker;

FIG. 2 shows a structural breakdown of MOF-5 to its SBUs;

FIG. 3 shows a structural breakdown of HKUST-1 to its SBUs;

FIG. 4 shows a structural breakdown of UiO-66 to its SBUs;

FIG. 5 shows a structural breakdown of DUT-60 to its SBUs;

FIG. 6 shows a map of all the chemical reactions carried out through the transformation of the core unit, 2,5-diphenyloxazole, into three organic linkers, 2,5-bis(4-carboxyphenyl)oxazole; 2,5-bis(4-(1H-tetrazole-5-yl)phenyl)oxazole; and 2,5-bis(4-carboxybiphenyl-4′-yl)oxazole for synthesizing new MOF compounds, according to certain embodiments;

FIG. 7A is a flowchart depicting a method of preparing a metal-organic framework (MOF), according to certain embodiments;

FIG. 7B is a flowchart depicting a method of preparing an oxazole-based organic linker, according to certain embodiments;

FIG. 8 shows a reaction scheme for the synthesis of 2,5-bis(4-nitrophenyl)oxazole of formula (IV), according to certain embodiments;

FIG. 9 shows a reaction scheme for the synthesis of 2,5-bis(4-aminophenyl)oxazole of formula (V), according to certain embodiments;

FIG. 10 shows a reaction scheme for the synthesis of 2,5-bis(4-iodophenyl)oxazole of formula (VI), according to certain embodiments;

FIG. 11 shows a reaction scheme for the synthesis of 2,5-bis(4-cyanophenyl)oxazole of formula (VII), according to certain embodiments;

FIG. 12 shows a reaction scheme for the synthesis of 2,5-bis(4-carboxyphenyl)oxazole of formula (I), according to certain embodiments;

FIG. 13 shows a reaction scheme for the synthesis of 2,5-bis(4-(1H-tetrazole-5-yl)phenyl)oxazole of formula (II), according to certain embodiments;

FIG. 14 shows a reaction scheme for the synthesis of 2,5-bis(4-carboxybiphenyl methyl ester 4′-yl)oxazole of formula (VIII), according to certain embodiments;

FIG. 15 shows a reaction scheme for the synthesis of 2,5-bis(4-carboxybiphenyl-4′-yl)oxazole of formula (III), according to certain embodiments;

FIG. 16A shows proton nuclear magnetic resonance (¹H NMR) spectrogram of formula (IV), according to certain embodiments;

FIG. 16B shows carbon-13 nuclear magnetic resonance (¹³C NMR) spectrogram of formula (IV), according to certain embodiments;

FIG. 17A shows ¹H NMR spectrogram of formula (V), according to certain embodiments;

FIG. 17B shows ¹³C NMR spectrogram of formula (V), according to certain embodiments;

FIG. 18A shows ¹H NMR spectrogram of formula (VI), according to certain embodiments;

FIG. 18B shows ¹³C NMR spectrogram of formula (VI), according to certain embodiments;

FIG. 19A shows ¹H NMR spectrogram of formula (VII), according to certain embodiments;

FIG. 19B shows ¹³C NMR spectrogram of formula (VII), according to certain embodiments;

FIG. 20A shows ¹H NMR spectrogram of formula (I), according to certain embodiments;

FIG. 20B shows ¹³C NMR spectrogram of formula (I), according to certain embodiments;

FIG. 21A shows ¹H NMR spectrogram of formula (II), according to certain embodiments;

FIG. 21B shows ¹³C NMR spectrogram of formula (II), according to certain embodiments;

FIG. 22A shows ¹H NMR spectrogram of formula (VIII), according to certain embodiments;

FIG. 22B shows ¹H NMR spectrogram of formula (III), according to certain embodiments;

FIG. 23 shows Fourier-transform infrared (FTIR) spectra of formula (IV), according to certain embodiments;

FIG. 24 shows FTIR spectra of formula (V), according to certain embodiments;

FIG. 25 shows FTIR spectra of formula (VI), according to certain embodiments;

FIG. 26 shows FTIR spectra of formula (VII), according to certain embodiments;

FIG. 27 shows FTIR spectra of formula (I), according to certain embodiments;

FIG. 28 shows FTIR spectra of formula (II), according to certain embodiments;

FIG. 29 shows an all-in-one stacked comparison of all FTIR spectra for compounds of formula (I, II, and IV to VII), showing the characteristic band of the functional groups in each compound, according to certain embodiments;

FIG. 30 shows powder X-ray diffraction (PXRD) patterns of various Zn-MOFs as compared with the pattern of the free organic linker of formula (I), according to certain embodiments;

FIGS. 31A-31B show scanning electron microscopic (SEM) micrographs of Zn-MOF-138-14 at different magnifications, according to certain embodiments; and

FIGS. 31C-31D shows SEM micrographs of Zn-MOF-138-15 at different magnifications, according to certain embodiments.

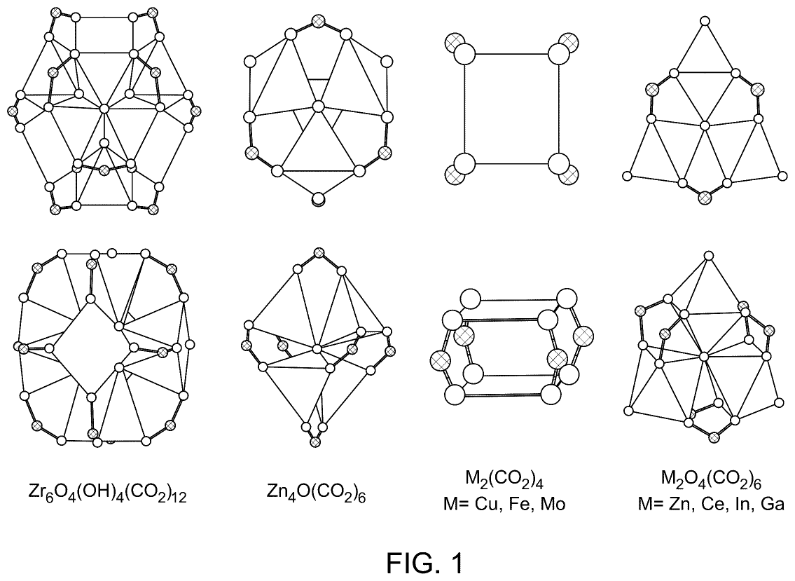

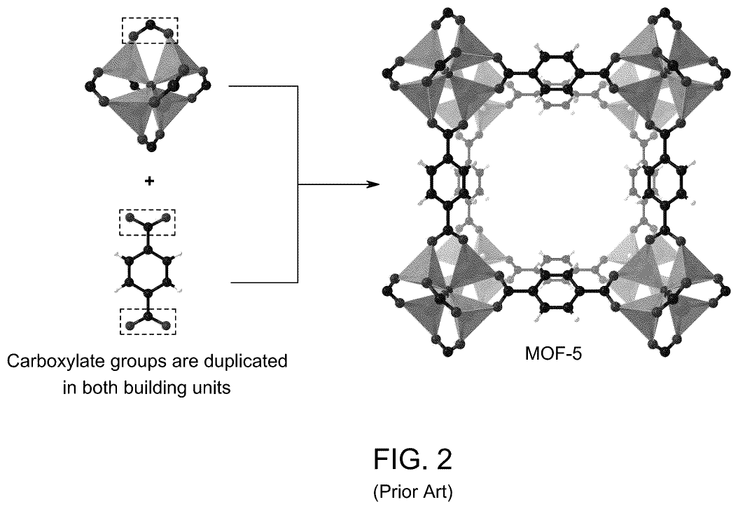

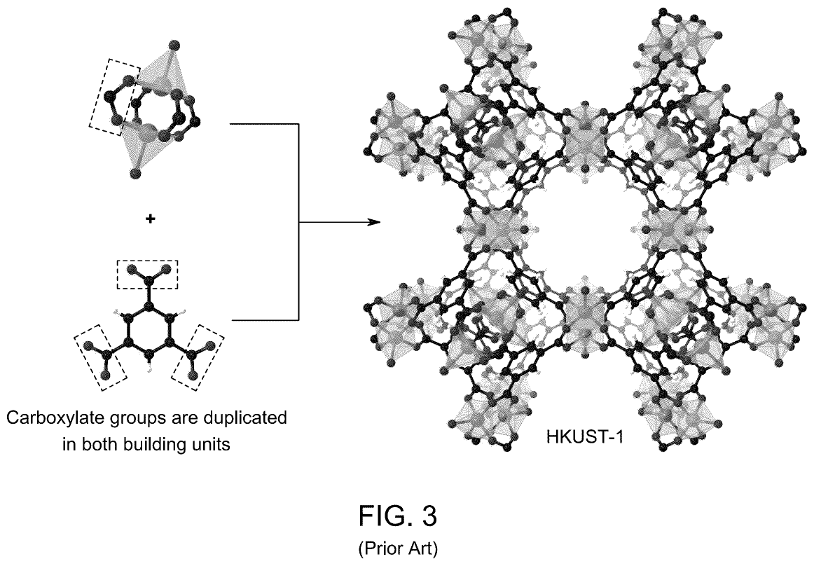

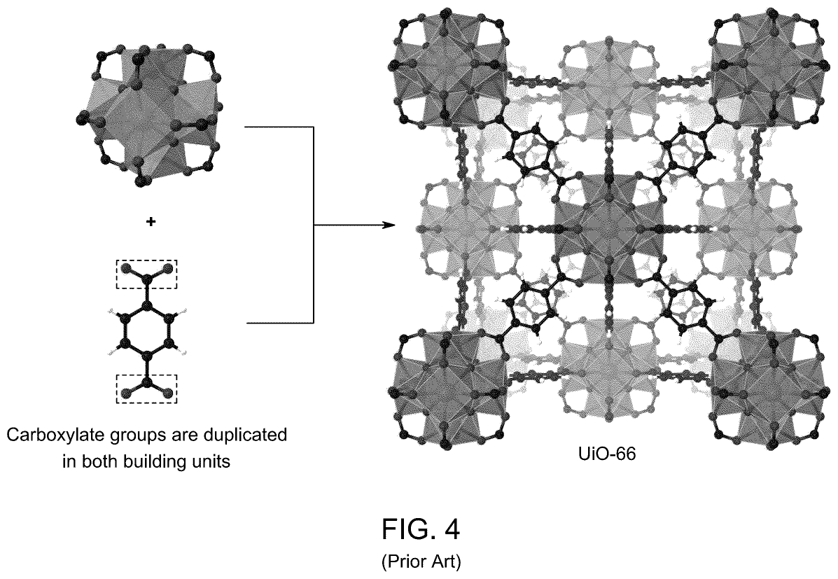

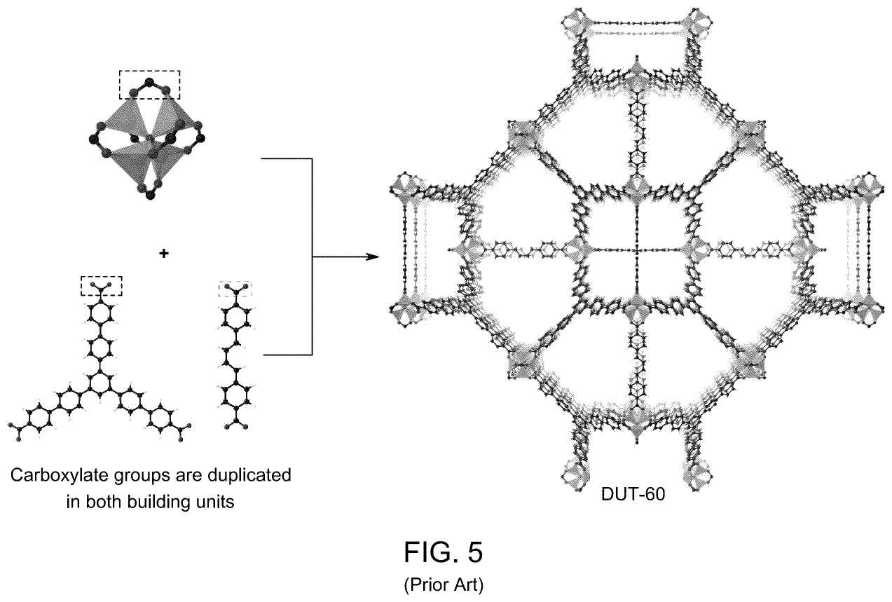

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, “particle size” may be thought of as the length or longest dimension of a particle.

As used herein, “metal-organic frameworks (MOFs)” refer to a class of compounds composed of metal clusters coordinated to organic ligands to form one-, two-, or three-dimensional structures.

As used herein, “Suzuki reaction” refers to a cross-coupling reaction between a boronic acid and an organohalide, catalyzed by a palladium (0) complex.

As used herein, a “cycloaddition reaction” is a type of chemical reaction where two or more unsaturated molecules or fragments of the same molecule combine to form a cyclic adduct.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

Aspects of the present disclosure are directed to MOFs, including the synthesis of a series of organic MOF linkers derived from the scintillator 2,5-diphenyloxazole. 2,5-diphenyloxazole is an organic scintillator commercially available from various vendors. Scintillation is the property of emitting radiation of a certain wavelength and frequency upon the excitation through absorption of another radiation having higher energy or, in some cases, the same energy. This property finds applications in high-energy radiation sensing. The oxazole ring may also present an active site for the absorption of carbon dioxide because of the presence of oxygen and nitrogen atoms that can physically adsorb the gas molecules through the interaction between the lone pairs on the heteroatoms and the electro-deficient carbon atom of the carbon dioxide.

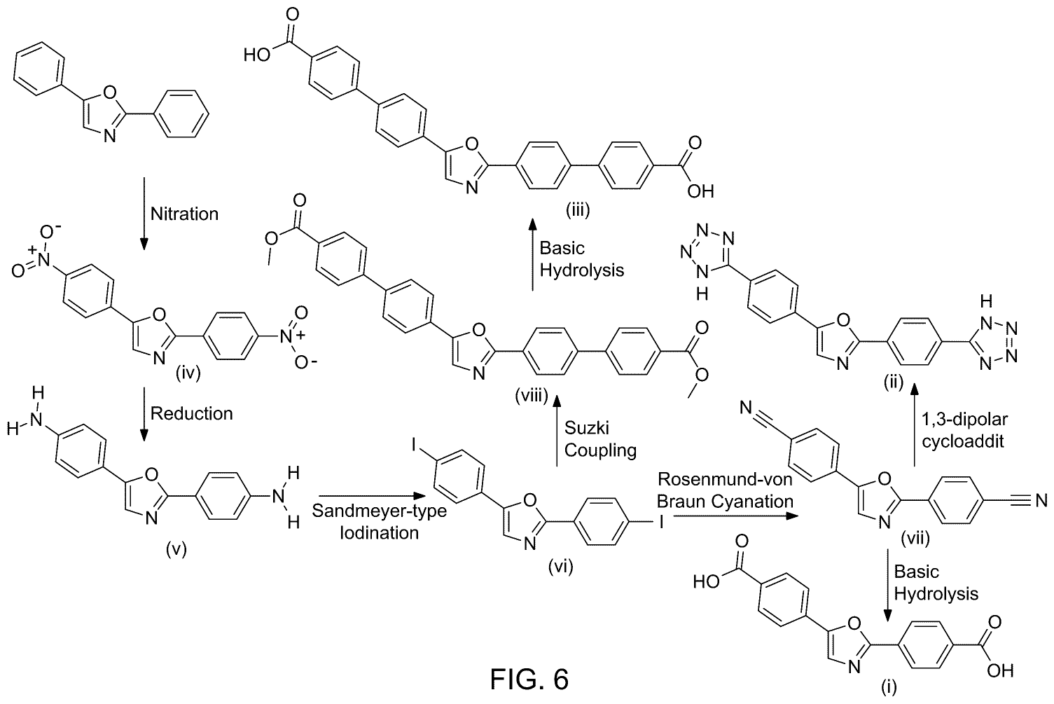

The preparation and structures of various derivatives of the core compound, 2,5-diphenyloxazole, such as nitro-, amino-, iodo-, and cyano-derivatives, are provided. The cyano-derivative, 2,5-bis(4-cyanophenyl)oxazole of formula (VII), was converted into two of the new MOF linkers, 2,5-bis(4-carboxyphenyl)oxazole of formula (I), and 2,5-bis(4-(1H-tetrazole-5-yl)phenyl)oxazole of formula (II). Additionally, the iodo-derivative, 2,5-bis(4-iodophenyl)oxazole of formula (VI), was converted into the extended linker 2,5-bis(4-carboxybiphenyl-4′-yl)oxazole of formula (VIII), which is the intermediate in synthesizing isoreticular MOFs to the 2,5-bis(4-carboxyphenyl)oxazole-based MOF. A schematic map of all the chemical reactions carried out through the transformation of the core unit, 2,5-diphenyloxazole, into three organic linkers, 2,5-bis(4-carboxyphenyl)oxazole of formula (I); 2,5-bis(4-(1H-tetrazole-5-yl)phenyl)oxazole of formula (II); and 2,5-bis(4-carboxybiphenyl-4′-yl)oxazole of formula (III) for synthesizing the MOF compounds is depicted in FIG. 6.

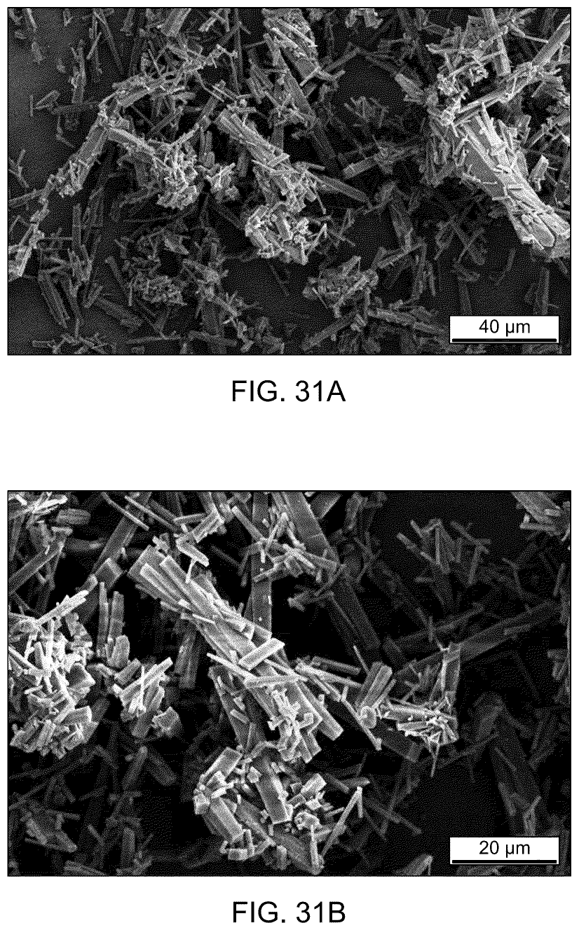

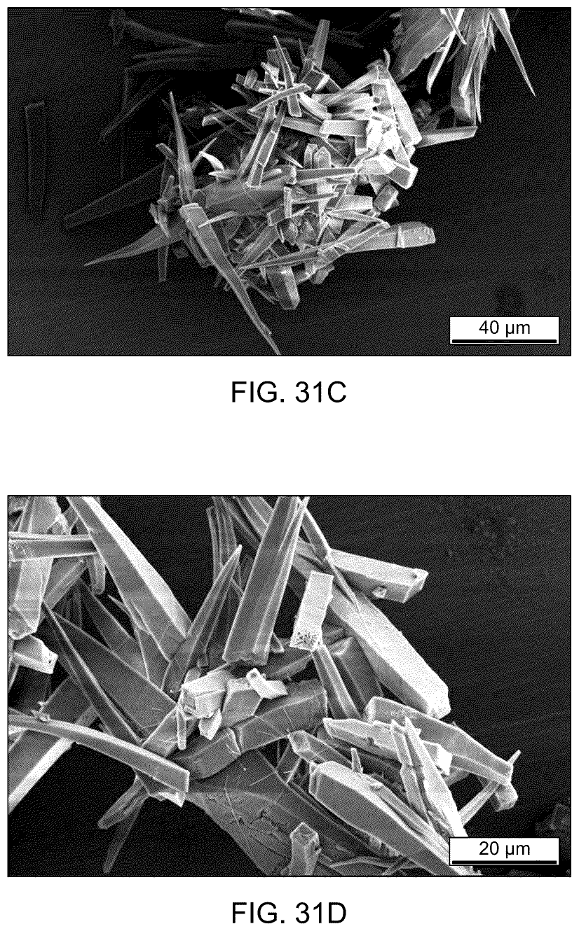

In one exemplary embodiment, a MOF is described. The MOF has a cross-linked porous reticular structure, including a plurality of extended tripodal and polyhedral units, including but not limited to cube, rectangular prism, tetrahedron, octahedron, dodecahedron, icosahedron, hexahedron, heptahedron, nonahedron, and decahedron, as depicted in FIGS. 31A to 31D. In some embodiments, a number ratio of the extended tripodal to the polyhedral units of the porous reticular structure is in a range of 100:1, preferably 80:1, preferably 60:1, preferably 40:1, preferably 20:1, or even more preferably 10:1. Other ranges are also possible.

In some embodiments, the MOF is in the form of particles having a particle size in a longest dimension of 1-80 μm, preferably 5-40 μm, preferably 6-39 μm, preferably 7-38 μm, preferably 8-37 μm, preferably 9-36 μm, preferably 10-35 μm, preferably 11-34 μm, preferably 12-33 μm, preferably 13-32, preferably 14-31 μm, preferably 15-30 μm, preferably 16-29 μm, preferably 17-28 μm, preferably 18-27 μm, preferably 19-26 μm, preferably 20-25 μm, preferably 21-24 μm, or even more preferably 22-23 μm, as depicted in FIGS. 31A to 31D. Other ranges are also possible.

In some embodiments, a height of the extended tripodal units generally refers to a perpendicular distance between the base plane and the topmost point along its longest dimension of the extended tripodal units. In some embodiments, a width of the extended tripodal units generally refers to a widest distance of the lateral extent along the base plane. In some embodiments, a ratio of the height to the width is in range of 50:1, preferably 40:1, preferably 30:1, preferably 20:1, preferably 10:1, or even more preferably about 5:1. Other ranges are also possible.

In some embodiments, the MOF includes one or more metal ions and one or more oxazole-based organic linkers. In some embodiments, the one or more metal ions are linked to the one or more oxazole-based organic linkers through a nitrogen atom of the oxazole core. In some embodiments, the MOF has a diamondoid framework comprising the one or more metal ions bridged by the one or more of the oxazole-based organic linkers. In some embodiments, one or more metal ions are selected from the group, including zirconium, zinc, titanium, copper, nickel, cobalt, and iron.

In some embodiments, each of the one or more oxazole-based organic linkers includes two or more, preferably two, preferably three, and preferably four substituted aromatic rings. In some embodiments, the one or more oxazole-based organic linkers are selected from the group consisting of 2,5-bis(4-carboxyphenyl)oxazole of formula (I), 2,5-bis(4-(1H-tetrazole-5-yl)phenyl)oxazole of formula (II), and 2,5-bis(4-carboxybiphenyl-4′-yl)oxazole of formula (III),

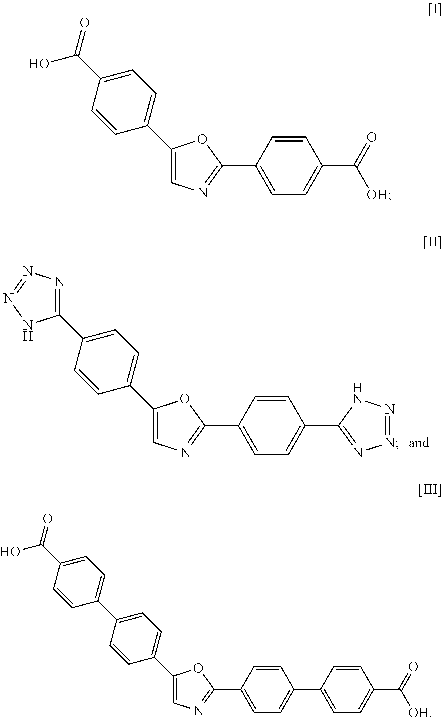 [SMILES: O=C(O)c1ccc(-c2cnc(-c3ccc(C(=O)O)cc3)o2)cc1 ; c1cc(-c2cnc(-c3ccc(-c4nnn[nH]4)cc3)o2)ccc1-c1nnn[nH]1 ; "and" ; O=C(O)c1ccc(-c2ccc(-c3cnc(-c4ccc(-c5ccc(C(=O)O)cc5)cc4)o3)cc2)cc1]

In some embodiments, the two or more substituted aromatic rings define planes that are substantially parallel with each other.

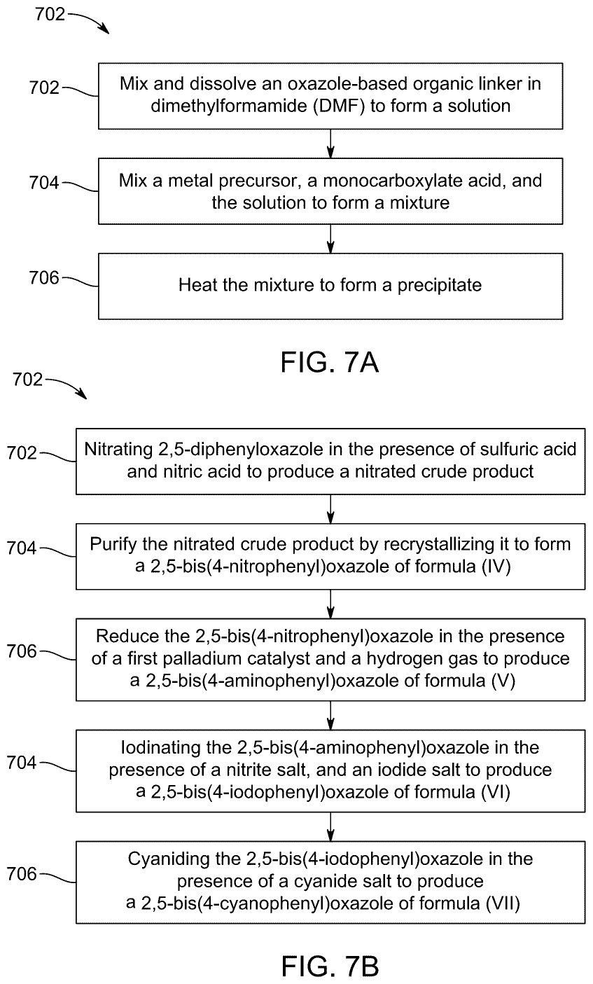

Referring to FIG. 7A, a flow chart of method 700 of making the metal-organic framework (MOF) is illustrated. The order in which the method 700 is described is not intended to be construed as a limitation, and any number of the described method steps can be combined in any order to implement the method 700. Additionally, individual steps may be removed or skipped from the method 700 without departing from the spirit and scope of the present disclosure.

At step 702, the method 700 includes mixing and dissolving an oxazole-based organic linker in an organic solvent, e.g., preferably dimethylformamide (DMF), to form a solution. In some embodiments, the oxazole-based organic linkers are one or more selected from 2,5-bis(4-carboxyphenyl)oxazole of formula (I), 2,5-bis(4-(1H-tetrazole-5-yl)phenyl)oxazole of formula (II), and 2,5-bis(4-carboxybiphenyl-4′-yl)oxazole of formula (III). In some embodiments, the oxazole-based organic linker is dissolved in DMF to form the solution. Optionally, other organic solvents may be used independently or in combination with DMF to form the solution. Suitable examples of the organic solvents include methanol, ethanol, acetone, dimethyl sulfoxide (DMSO), dimethylacetamide, isopropanol, benzene, hexane, carbon tetrachloride, toluene, diethyl ether, and chloroform. The mixing may be carried out manually or with the help of a stirrer. Dissolution may be done via stirring, swirling, or sonicating. In some embodiment,

At step 704, the method 700 includes mixing a metal precursor, a monocarboxylate acid, and the solution to form a mixture. In some embodiments, the mixing may be carried out manually or with the help of a stirrer. In some embodiments, the metal precursor is at least one selected from the group consisting of a zirconium salt, a zinc salt, a titanium salt, a copper salt, a nickel salt, a cobalt salt, and an iron salt. Suitable examples of nickel salt include nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate. Suitable examples of zinc salt include zinc sulfate, zinc acetate, zinc citrate, zinc iodide, zinc chloride, zinc perchlorate, zinc nitrate, zinc phosphate, zinc triflate, zinc bis(trifluoromethanesulfonyl)imide, zinc tetrafluoroborate, and zinc bromide, or its hydrate, or mixtures thereof. Suitable examples of zirconium salts include zirconium acetate, zirconium acrylate, zirconium carboxylate, zirconium sulfate, zirconium hydroxide, zirconium nitrate, zirconium oxynitrate, zirconium oxide, zirconium oxychloride, and zirconium chloride, or its hydrate, or mixtures thereof. Suitable examples of titanium salts include ammonium hexafluorotitanate, potassium titanate, titanium sulfate, titanium sulfate, titanium chloride, titanium nitrate, titanyl sulfate, titanium fluoride, titanium laurate, titanium oxysulfate, basic titanium phosphate, titanium bromide or its hydrate, or mixtures thereof. Suitable examples of copper salts include copper benzoate, tetraammine copper nitrate, copper citrate, copper oxide, copper bromide, copper oxalate, copper bromide, copper chloride, copper chloride, copper nitrate, copper sulfate, copper carbonate, copper oxide, copper fluoride and copper iodide. Suitable examples of cobalt salts include cobalt chloride, chloropentahammine cobalt chloride, hexaammine cobalt chloride, cobalt phosphate, cobalt phosphate, ammonium cobalt sulfate, diammonium tetra nitrate cobalt, cobalt acetate, cobalt formate, cobalt tetraoxide, cobalt bromide, cobalt oxalate, cobalt selenate, cobalt tungstate, cobalt molybdate, cobalt iodide, and cobalt phosphate or its hydrate, or mixtures thereof. Suitable examples of iron salts include iron bromide, iron chloride, iron phosphate hydrate, iron phosphate tetrahydrate, iron chloride hydrate, iron chloride tetrahydrate, iron fluoride, ammonium iron sulfate hexahydrate, iron citrate tribasic monohydrate, iron gluconate dehydrate, iron pyrophosphate, iron phthalocyanine, iron phthalocyanine chloride, ammonium iron citrate, ammonium iron sulfate, ammonium iron sulfate, ammonium iron sulfate dodecahydrate, iron chloride, iron bromide, iron chloride hexahydrate, ferric citrate, iron fluoride, iron nitrate nonahydrate, iron oxide, iron phosphate, iron sulfate hydrate, iron gluconate hydrate, iron iodide, iron lactate hydrate, iron oxalate dehydrate, ferrous sulfate heptahydrate, iron sulfide, iron acetate, iron fluoride tetrahydrate, iron iodide tetrahydrate, iron perchlorate hydrate, iron acetylacetonate, iron acetylacetonate, and iron ascorbate or its hydrate, or mixtures thereof. In a preferred embodiment, the copper salt is copper acetate monohydrate and copper nitrate pentahydrate. In a preferred embodiment, the zinc salt is zinc acetate dihydrate and zinc nitrate hexahydrate. In a preferred embodiment, the zirconium salt is anhydrous zirconium chloride. In some embodiments, the metal precursor is present in the mixture at a concentration in a range of 0.05-0.5 M, preferably 0.1-0.45, preferably 0.15-0.4, preferably 0.2-0.35, and preferably 0.25-0.3 M. Other ranges are also possible. In some embodiments, monocarboxylate acid may be at least one of formic acid, acetic acid, propanoic acid, and butanoic acid. In a preferred embodiment, the monocarboxylate acid is acetic acid.

At step 706, the method 700 includes heating the mixture to form a precipitate. The heating can be done by using heating appliances such as ovens, microwaves, autoclaves, hot plates, heating mantles and tapes, oil baths, salt baths, sand baths, air baths, hot-tube furnaces, and hot-air guns. At step 708, the method 700 includes separating the precipitate from the mixture, washing, and drying to form the MOF. The separation of the precipitate from the mixture can be done by filtration or centrifugation. The washing of the precipitate may be done by using a solvent like water, organic solvents like alcohol, acetone, or a mixture thereof. The drying of the precipitate can be done by using heating appliances such as ovens, microwaves, autoclaves, hot plates, heating mantles and tapes, oil baths, salt baths, sand baths, air baths, hot-tube furnaces, and hot-air guns.

The crystalline structures of the Zn-MOFs may be characterized by X-ray diffraction (XRD). In some embodiments, the XRD may be at least one of a wide-angle XRD, a powder X-ray diffraction (PXRD), and a single crystal X-ray diffraction (SCXRD). In some embodiments, the SCXRD patterns are collected in a Rigaku Ultima IV diffractometer equipped with a Cu-Kα radiation source (2=0.1541 Å) for a 20 range extending between 5 and 80°, preferably 15 and 70°, further preferably 30 and 60° at an angular rate of 0.005 to 0.04° s⁻¹, preferably 0.01 to 0.03°s 1, or even preferably 0.02° s⁻¹. In some embodiments, the SCXRD patterns are collected in a Bruker AXS D8 Quest diffractometer equipped with a microfocus sealed Mo-Kα radiation source (λ=0.71073 Å) for a 20 range extending between 5 and 80°, preferably 15 and 70°, further preferably 30 and 60° at an angular rate of 0.005 to 0.04° s⁻¹, preferably 0.01 to 0.03° s⁻¹, or even preferably 0.02° s⁻¹.

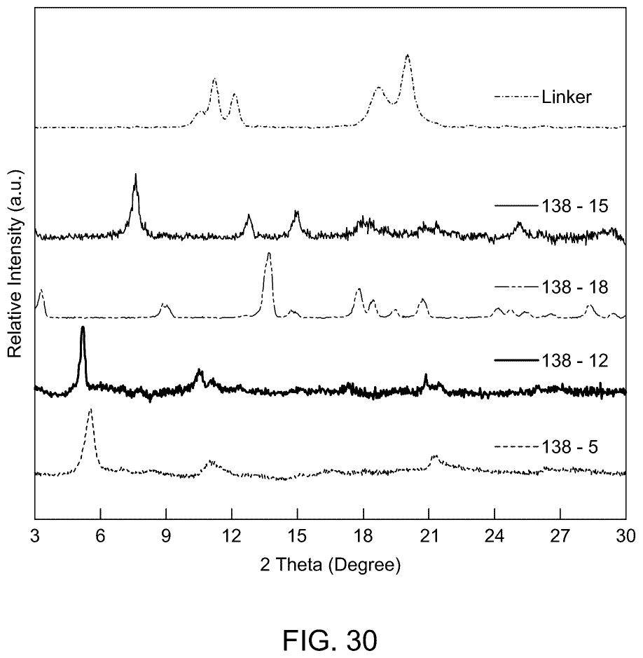

Referring to FIG. 30, in some embodiments, when the metal precursor includes a zinc salt, and the oxazole-based organic linker is formula (I), the Zn-MOF has peaks with a 2-theta value of 5-6°, preferably 5.1-5.9°, preferably 5.2-5.8°, preferably 5.3-5.7°, preferably 5.4-5.6° and 6.5-9.5°, preferably 7.0-9.0°, preferably 7.5-8.5°, as determined by powder X-ray diffraction (PXRD) spectrum. In some embodiments, the Zn-MOF has peaks with a 2θ value in a range of 10.0-14.0°, preferably 11 to 13°, as depicted in FIG. 30. In some further embodiments, the Zn-MOF has peaks with a 2θ value in a range of 17.0-25.0°, preferably 19 to 22°, as depicted in FIG. 30. Other ranges are also possible.

Referring to FIG. 7B, a flow chart of method 750 of preparing the oxazole-based organic linker is illustrated. The order in which the method 750 is described is not intended to be construed as a limitation, and any number of the described method steps can be combined in any order to implement the method 750. Additionally, individual steps may be removed or skipped from the method 750 without departing from the spirit and scope of the present disclosure.

At step 752, the method 750 includes nitrating 2,5-diphenyloxazole in the presence of sulfuric acid and nitric acid to produce a nitrated crude product. The volume by volume (v/v) ratio of sulfuric acid to nitric acid is in the range of 1:5 to 5:1, preferably 1:4 to 4:1, preferably 1:3 to 3:1, preferably 2:1 to 1:2, and preferably 1:1. The nitration is preferably carried out at a temperature range of 0 to 15° C., or even more preferably about 0 to 5° C. Other ranges are also possible.

At step 754, the method 750 includes purifying the nitrated crude product by recrystallizing it to form a 2,5-bis(4-nitrophenyl)oxazole of formula (IV). Optionally, other purification techniques known in the art may be performed as well to remove any undesired regioisomers and/or impurities.

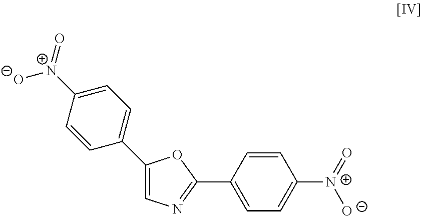 [SMILES: O=[N+]([O-])c1ccc(-c2cnc(-c3ccc([N+](=O)[O-])cc3)o2)cc1]

At step 756, the method 750 includes reducing the 2,5-bis(4-nitrophenyl)oxazole in the presence of a first palladium catalyst and a hydrogen gas to produce a 2,5-bis(4-aminophenyl)oxazole of formula (V). Optionally, other metal catalysts, such as platinum, nickel, ruthenium, and rhodium, may be used independently/in combination with the first palladium catalyst. In some embodiments, the first palladium catalyst is a palladium/carbon catalyst having a palladium concentration of about 1-8 wt. %, preferably 2-7, preferably 3-6, preferably 4-5 wt. %, based on the total weight of the palladium/carbon catalyst. In a preferred embodiment, the first palladium catalyst has a palladium concentration of 5 wt. % based on the total weight of the palladium/carbon catalyst. Other ranges are also possible.

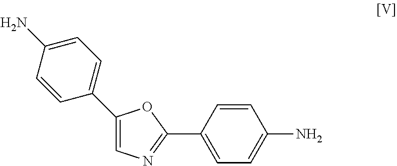 [SMILES: Nc1ccc(-c2cnc(-c3ccc(N)cc3)o2)cc1]

At step 758, the method 750 includes iodinating the 2,5-bis(4-aminophenyl)oxazole in the presence of a nitrite salt, and an iodide salt to produce a 2,5-bis(4-iodophenyl)oxazole of formula (VI). In some embodiments, the nitrite salt is at least one selected from the group consisting of sodium nitrite, and potassium nitrite. In a specific embodiment, the nitrite salt is sodium nitrite. Suitable examples of the iodide salt include potassium iodate, potassium iodide, sodium iodate, and sodium iodide. In a preferred embodiment, the iodide salt is potassium iodide.

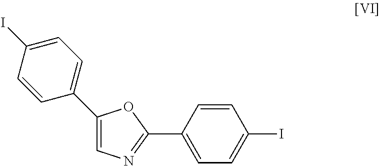 [SMILES: Ic1ccc(-c2cnc(-c3ccc(I)cc3)o2)cc1]

The 2,5-bis(4-iodophenyl)oxazole of formula (VI) may be used as a starting point to prepare 2,5-bis(4-carboxybiphenyl-4′-yl)oxazole of formula (III). The 2,5-bis(4-carboxybiphenyl-4′-yl)oxazole of formula (III) may be prepared by reacting the 2,5-bis(4-iodophenyl)oxazole in the presence of a second palladium salt and an arylboronic acid via a Suzuki cross-coupling reaction to produce a 2,5-bis(4-carboxybiphenyl methyl ester 4′-yl)oxazole of formula (VIII). In some embodiments, the arylboronic acid is at least one of 4-ethoxycarbonylphenylboronic acid, 4-methoxycarbonylphenylboronic acid, 3-ethoxycarbonylphenylboronic acid, and phenylboronic acid. In some preferred embodiments, the arylboronic acid is 4-ethoxycarbonylphenylboronic acid.

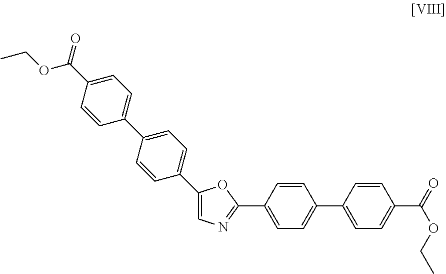 [SMILES: CCOC(=O)c1ccc(-c2ccc(-c3cnc(-c4ccc(-c5ccc(C(=O)OCC)cc5)cc4)o3)cc2)cc1]

In some embodiments, the second palladium salt is palladium (II) acetate having a palladium concentration of about 45-50 wt. %, preferably 46-49 wt. %, preferably 47-48 wt. %, based on a total weight of the palladium (II) acetate, and the arylboronic acid is 4-ethoxycarbonylphenylboronic acid. In some embodiments, the method further includes hydrolyzing the 2,5-bis(4-carboxybiphenyl methyl ester 4′-yl)oxazole in the presence of a base at a temperature of about 50-90° C., preferably 51-89, preferably 52-88, preferably 53-87, preferably 54-86, preferably 55-85, preferably 56-84, preferably 57-83, preferably 58-82, preferably 59-81° C., preferably 60-80° C., preferably 61-79, preferably 62-77, preferably 63-77, preferably 64-76, preferably 55-75, preferably 66-74, preferably 67-73, preferably 68-72, and preferably 69-71° C. Other ranges are also possible.

At step 760, the method 750 includes cyaniding the 2,5-bis(4-iodophenyl)oxazole in the presence of a cyanide salt to produce a 2,5-bis(4-cyanophenyl)oxazole of formula (VII). Suitable examples of cyanide salt include calcium cyanide, potassium cyanide, and sodium cyanide. In a preferred embodiment, the cyanide salt is potassium cyanide.

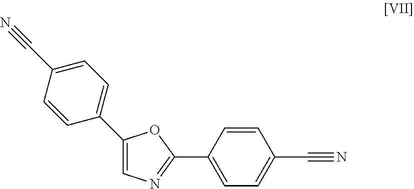 [SMILES: N#Cc1ccc(-c2cnc(-c3ccc(C#N)cc3)o2)cc1]

In some embodiments, the method includes hydrolyzing the 2,5-bis(4-cyanophenyl)oxazole in the presence of a base at a temperature of about 90-100° C., preferably 91-99° C., preferably 92-98° C., preferably 93-97° C., and preferably 94-96° C., to prepare the 2,5-bis(4-carboxyphenyl)oxazole of formula (I) to produce a 2,5-bis(4-carboxyphenyl)oxazole of formula (I) by. In some embodiments, the base is at least one selected from the group consisting of lithium hydroxide, sodium hydroxide, potassium hydroxide, and calcium hydroxide. In a preferred embodiment, the base is sodium hydroxide. In a preferred embodiment, hydrolysis of 2,5-bis(4-cyanophenyl)oxazole occurs in the presence of sodium hydroxide at a temperature of about 95° C. Other ranges are also possible.

In some embodiments, the method further includes reacting the 2,5-bis(4-cyanophenyl)oxazole and an azide compound in the presence of an indium salt by a cycloaddition reaction at a temperature of about 130-150° C., preferably 131-149, preferably 132-148, preferably 133-147, preferably 134-146, preferably 135-145, preferably 136-144, preferably 137-143, preferably 138-142, and preferably 139-141° C. to prepare 2,5-bis(4-(1H-tetrazole-5-yl)phenyl)oxazole of formula (II). In some embodiments, the azide compound is at least one selected from the group consisting of sodium azide, potassium azide, and calcium azide. In a preferred embodiment, the azide compound is sodium azide. In some embodiments, the indium salt is indium chloride. Optionally, other indium salts, such as indium bromide, indium fluoride, indium nitrate, indium sulfate, or metallic indium, alone or in combination thereof, may be used as well.

The structures of the compounds of formula (I-VIII) may be characterized by Fourier transforms infrared spectroscopy (FT-IR). In some embodiments, the FT-IR may be collected in a PerkinElmer 16 PC spectrometer acquired in a range of 4000 to 500 centimeter inverse (cm⁻¹) at 4 cm⁻¹ resolution. 20 scans were carried out for each sample.

The structures of the compounds of formula (I-VIII) may be characterized by nuclear magnetic resonance (NMR) spectroscopy. In some embodiments, the NMR may be collected in a Bruker 400 MHz spectrometer.

¹H and ¹³C NMR spectra may be recorded using the residual DMSO-do at δ 2.50 ppm, 13C DMSO-d₆ signal at δ 39.52 ppm, CDCl₃-d at δ 7.24 ppm, and 13C CDCl₃-d signal at δ 77.23 ppm, as internal standards.

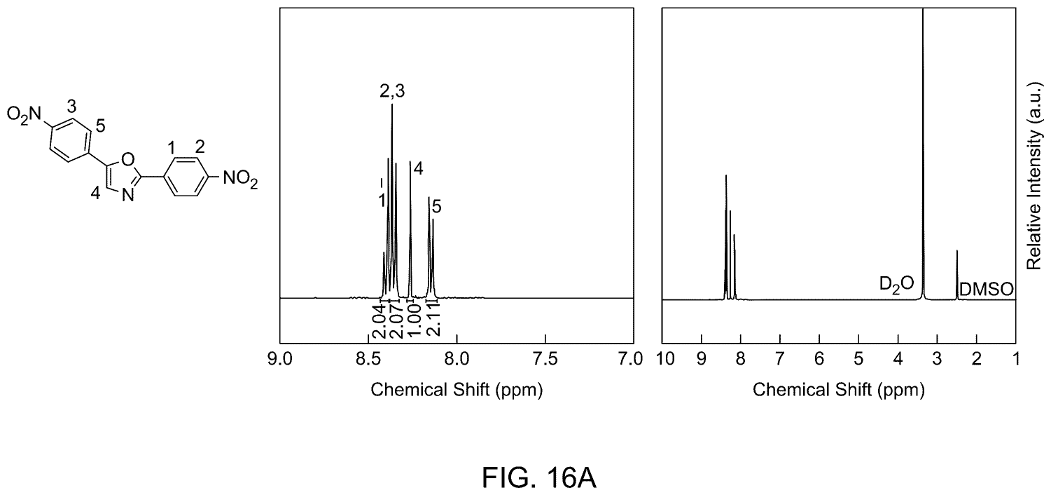

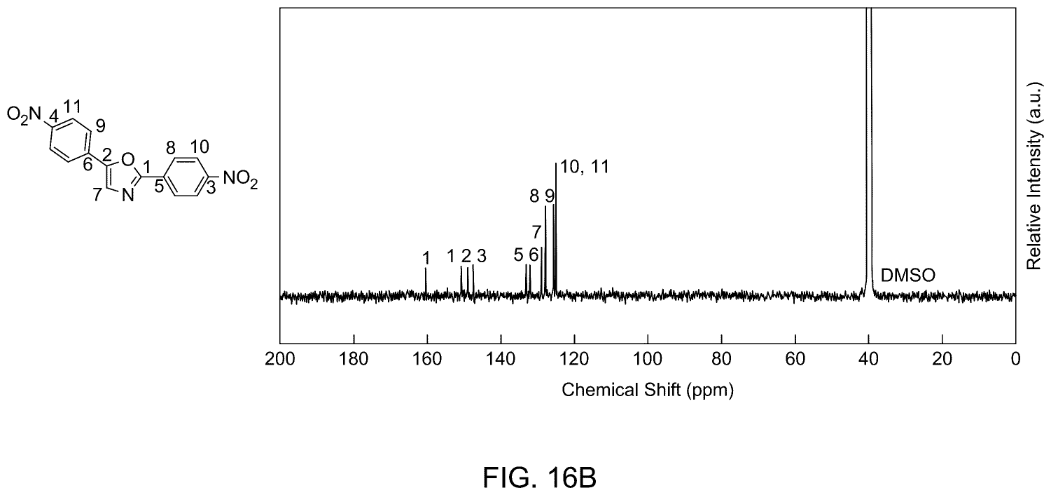

Referring to FIG. 16A, ¹H NMR spectra of 2,5-bis(4-nitrophenyl)oxazole of formula (IV) in DMSO-d₆. In some embodiments, the 2,5-bis(4-nitrophenyl)oxazole of formula (IV) has peaks in a range of 8 to 9, or more preferably about 8.16, about 8.27, about 8.37, and about 8.41 ppm, as depicted in FIG. 16A. Other ranges are also possible.

Referring to FIG. 16B, ¹³C NMR spectra of 2,5-bis(4-nitrophenyl)oxazole of formula (IV) in DMSO-d₆. In some embodiments, the 2,5-bis(4-nitrophenyl)oxazole of formula (IV) has peaks in a range of 110 to 170, or more preferably about 124.56, about 124.57, about 125.27, about 127.51, about 128.60, about 131.70, about 132.85, about 147.03, about 148.58, about 150.25, and about 159.89 ppm, as depicted in FIG. 16B. Other ranges are also possible.

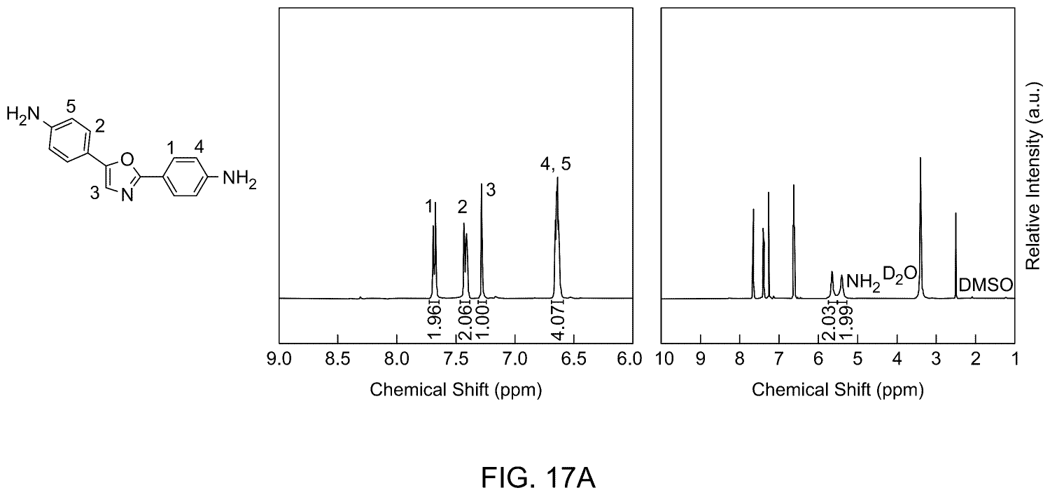

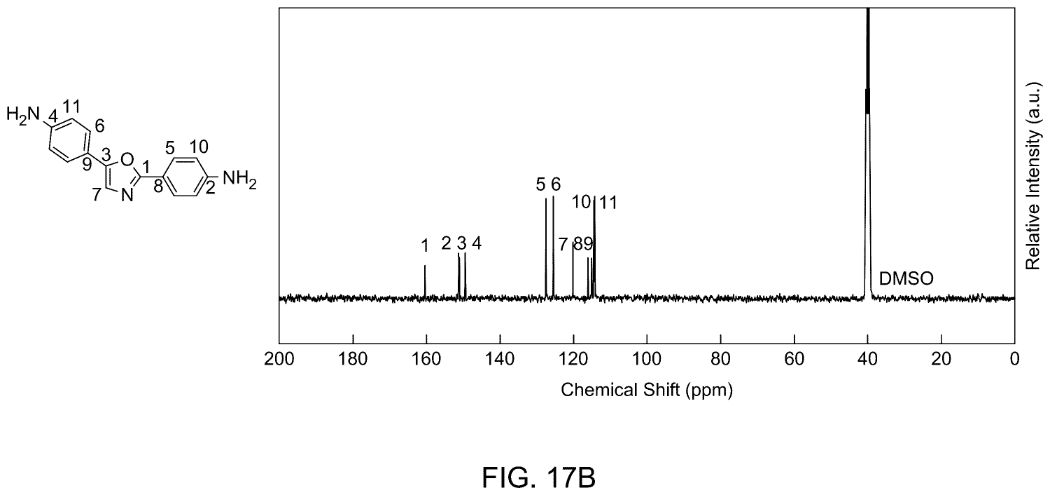

Referring to FIG. 17A, ¹H NMR spectra of 2,5-bis(4-aminophenyl)oxazole of formula (V) in DMSO-d₆. In some embodiments, the 2,5-bis(4-aminophenyl)oxazole of formula (V) has peaks in a range of 5 to 8, or more preferably about 5.42, about 5.67, about 6.65, about 7.28, about 7.42, and about 7.69 ppm, as depicted in FIG. 17A. Other ranges are also possible.

Referring to FIG. 17B, ¹³C NMR spectra of 2,5-bis(4-aminophenyl)oxazole of formula (V) in DMSO-d₆. In some embodiments, the 2,5-bis(4-aminophenyl)oxazole of formula (V) has peaks in a range of 110 to 170, or more preferably about 114.0, about 114.4, about 115.0, about 116.0, about 120.2, about 125.4, about 127.5, about 149.4, about 150.8, about 151.2, and about 160.3 ppm, as depicted in FIG. 17B. Other ranges are also possible.

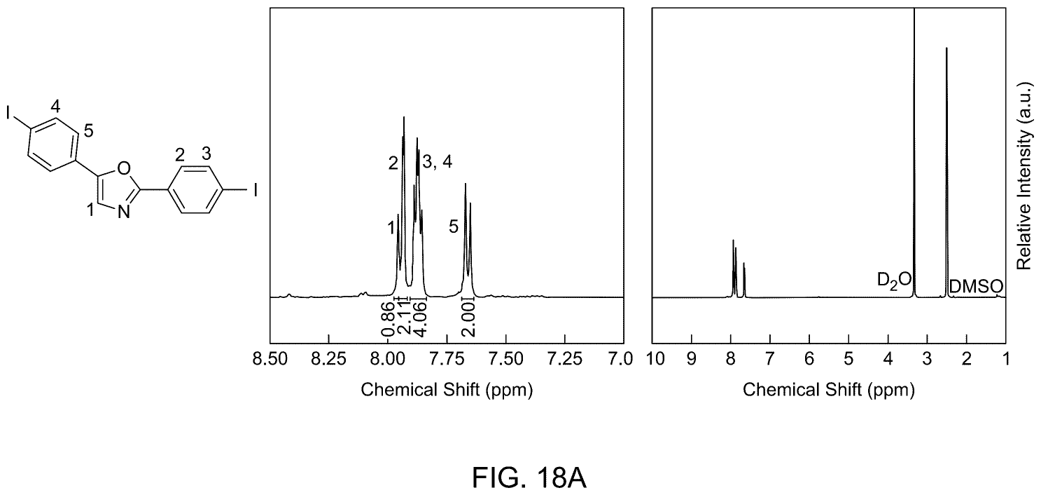

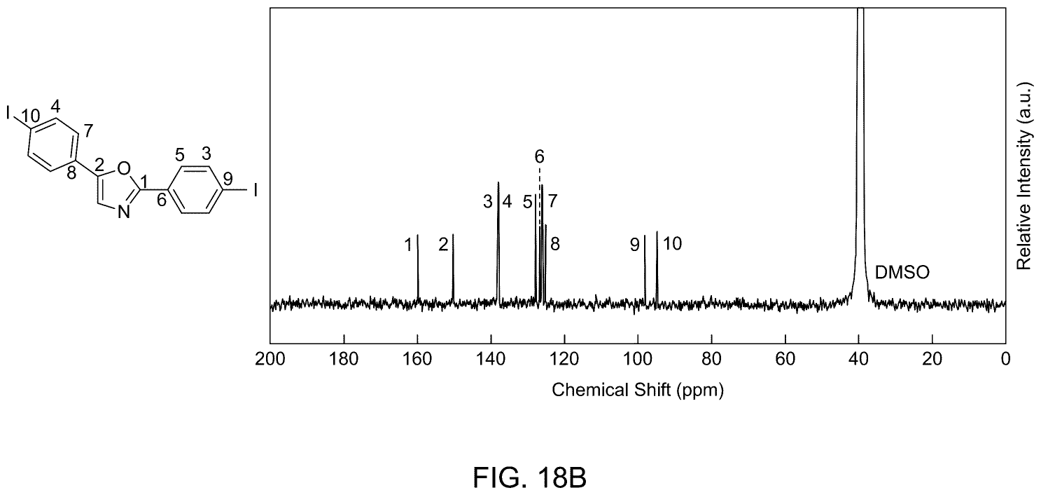

Referring to FIG. 18A, ¹H NMR spectra of 2,5-bis(4-iodophenyl)oxazole of formula (VI) in DMSO-d₆. In some embodiments, the 2,5-bis(4-iodophenyl)oxazole of formula (VI) has peaks in a range of 7 to 8.5, or more preferably about 7.66, about 7.88, about 7.94, and about 7.96 ppm, as depicted in FIG. 18A. Other ranges are also possible.

Referring to FIG. 18B, ¹³C NMR spectra of 2,5-bis(4-iodophenyl)oxazole of formula (VI) in DMSO-d₆. In some embodiments, the 2,5-bis(4-iodophenyl)oxazole of formula (VI) has peaks in a range of 80 to 170, or more preferably about 94.97, about 98.05, about 125.14, about 126.01, about 126.76, about 127.79, about 137.90, about 138.07, about 150.26, and about 159.90 ppm, as depicted in FIG. 18B. Other ranges are also possible.

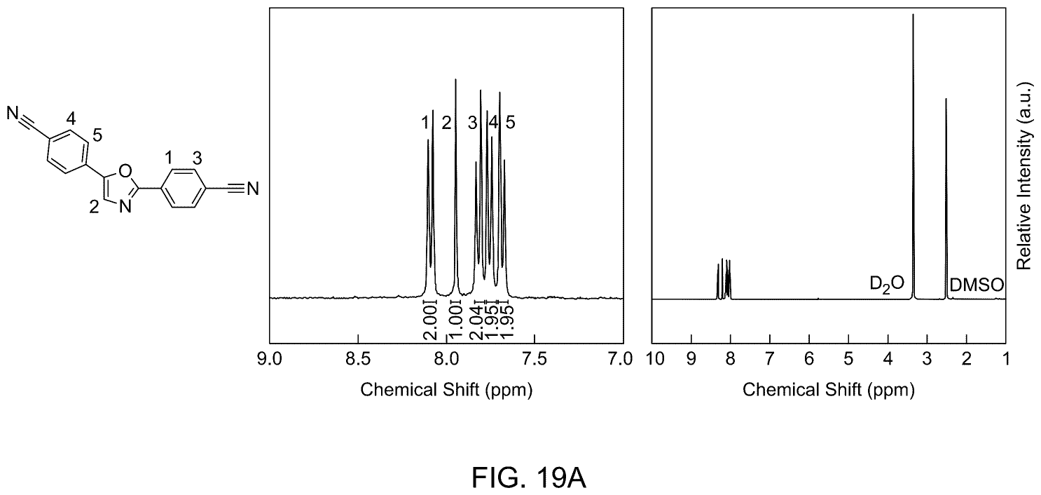

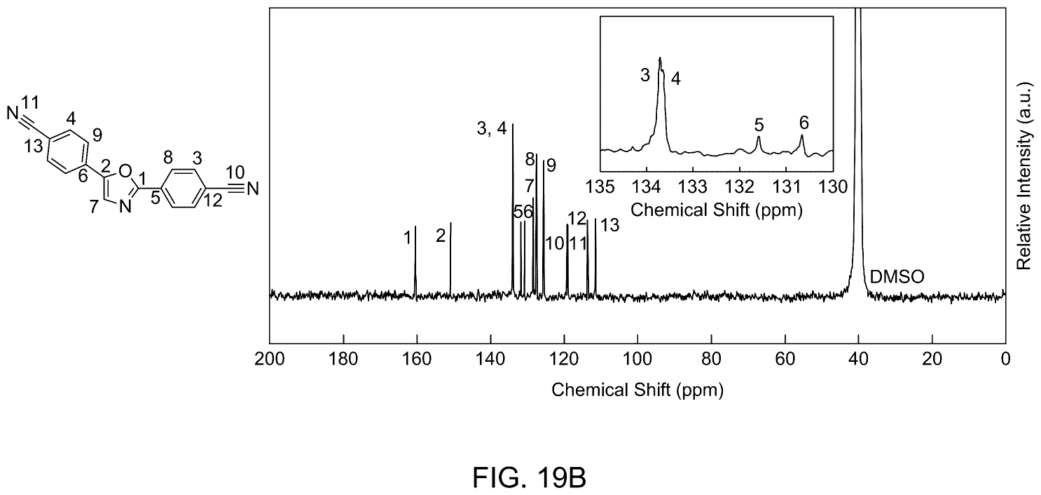

Referring to FIG. 19A, ¹H NMR spectra of 2,5-bis(4-cyanophenyl)oxazole of formula (VII) in DMSO-d₆. In some embodiments, the 2,5-bis(4-cyanophenyl)oxazole of formula (VII) has peaks in a range of 7.5 to 9, or more preferably about 8.00, about 8.06, about 8.10, about 8.20, and about 8.31 ppm, as depicted in FIG. 19A. Other ranges are also possible.

Referring to FIG. 19B, ¹³C NMR spectra of 2,5-bis(4-cyanophenyl)oxazole of formula (VII) in DMSO-d₆. In some embodiments, the 2,5-bis(4-cyanophenyl)oxazole of formula (VII) has peaks in a range of 100 to 170, or more preferably about 111.4, about 113.5, about 118.8, about 119.1, about 125.4, about 127.4, about 128.2, about 130.6, about 131.6, about 133.6, about 133.7, about 150.7, and 160.3 ppm, as depicted in FIG. 19B. Other ranges are also possible.

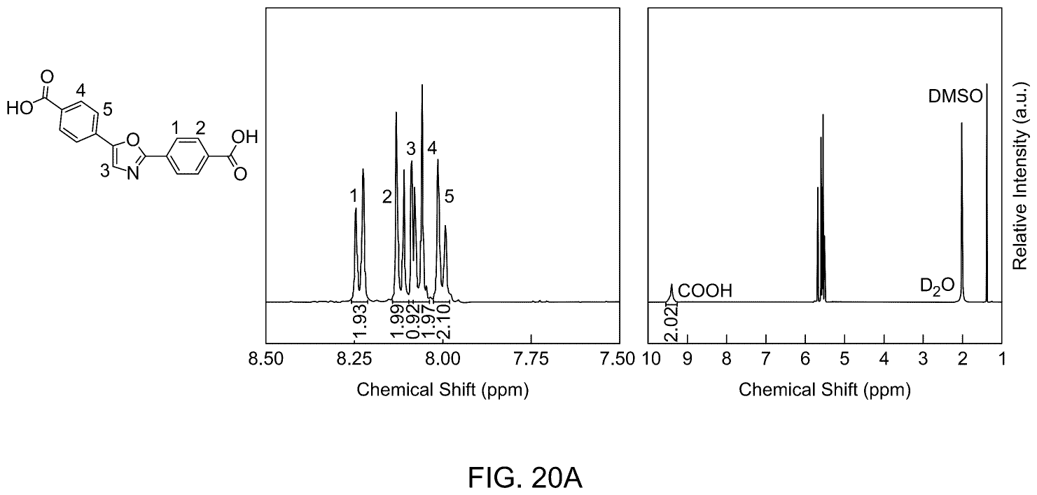

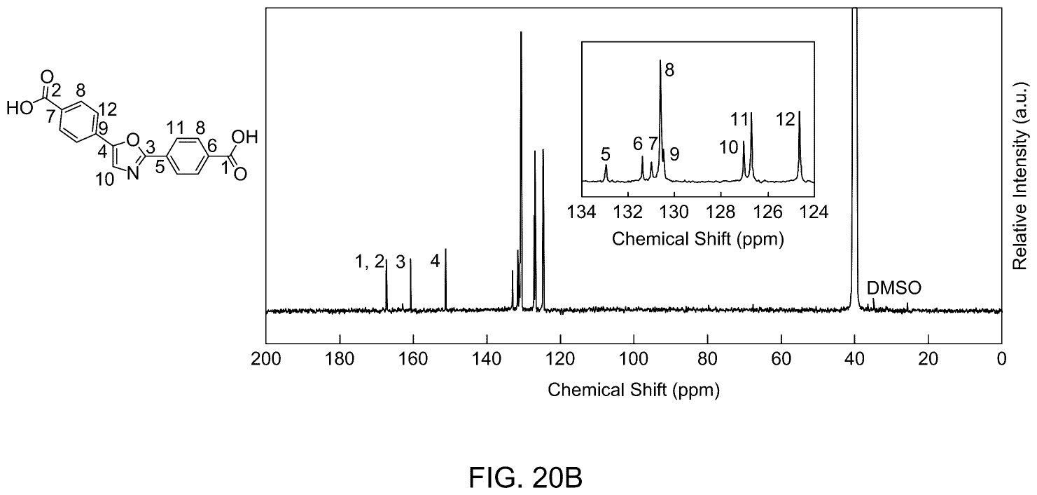

Referring to FIG. 20A, ¹H NMR spectra of 2,5-bis(4-carboxyphenyl)oxazole of formula (I) in DMSO-d₆. In some embodiments, the 2,5-bis(4-carboxyphenyl)oxazole of formula (I) has peaks in a range of 7.5 to 14, or more preferably about 8.01, about 8.07, about 8.08, about 8.12, about 8.24, and about 13.2 ppm, as depicted in FIG. 20A. Other ranges are also possible.

Referring to FIG. 20B, ¹³C NMR spectra of 2,5-bis(4-carboxyphenyl)oxazole of formula (I) in DMSO-d₆. In some embodiments, the 2,5-bis(4-carboxyphenyl)oxazole of formula (I) has peaks in a range of 110 to 180, or more preferably about 124.6, about 126.7, about 127.0, about 130.5, about 130.6, about 131.0, about 131.4, about 133.0, about 151.0, about 160.6, about 167.2, and about 167.3 ppm, as depicted in FIG. 20B. Other ranges are also possible.

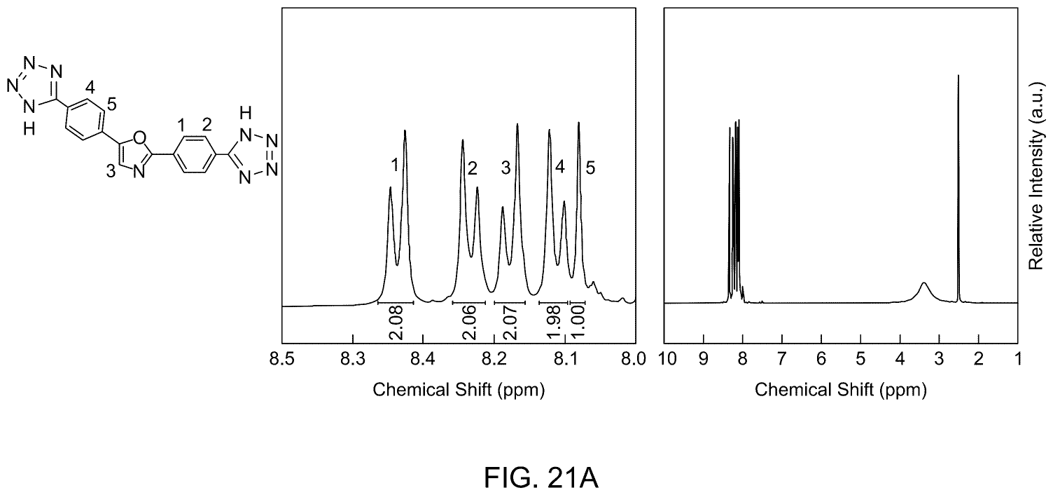

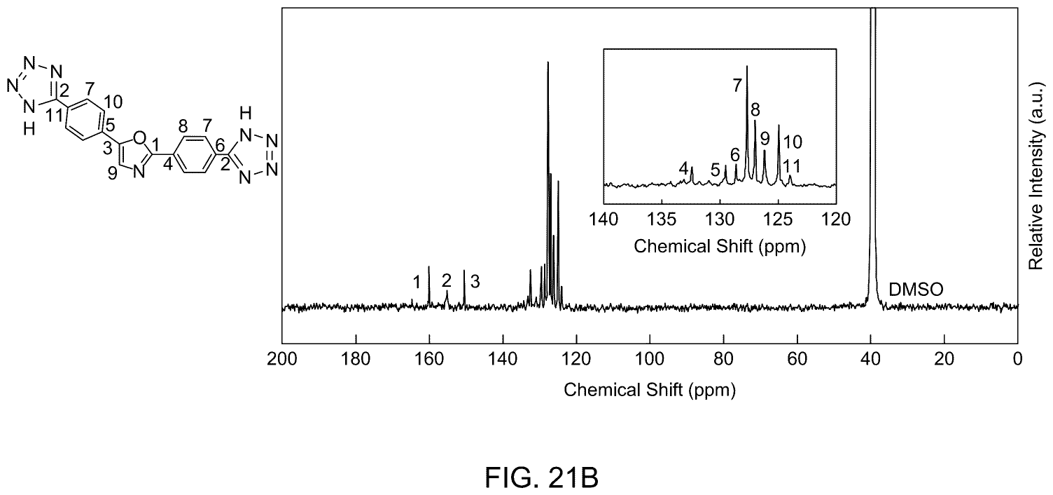

Referring to FIG. 21A, ¹H NMR spectra of 2,5-bis(4-(1H-tetrazole-5-yl)phenyl)oxazole of formula (II) in DMSO-d₆. In some embodiments, the 2,5-bis(4-(1H-tetrazole-5-yl)phenyl)oxazole of formula (II) has peaks in a range of 7.5 to 9, or more preferably about 8.09, about 8.13, about 8.19, about 8.25, and about 8.36 ppm, as depicted in FIG. 21A. Other ranges are also possible.

Referring to FIG. 21B, ¹³C NMR spectra of 2,5-bis(4-(1H-tetrazole-5-yl)phenyl)oxazole of formula (II) in DMSO-d₆. In some embodiments, the 2,5-bis(4-(1H-tetrazole-5-yl)phenyl)oxazole of formula (II) has peaks in a range of 110 to 180, or more preferably about 120 to 125, about 125 to 126, about 126 to 127, about 127 to 130, and about 132 to 134 ppm, as depicted in FIG. 21B. Other ranges are also possible.

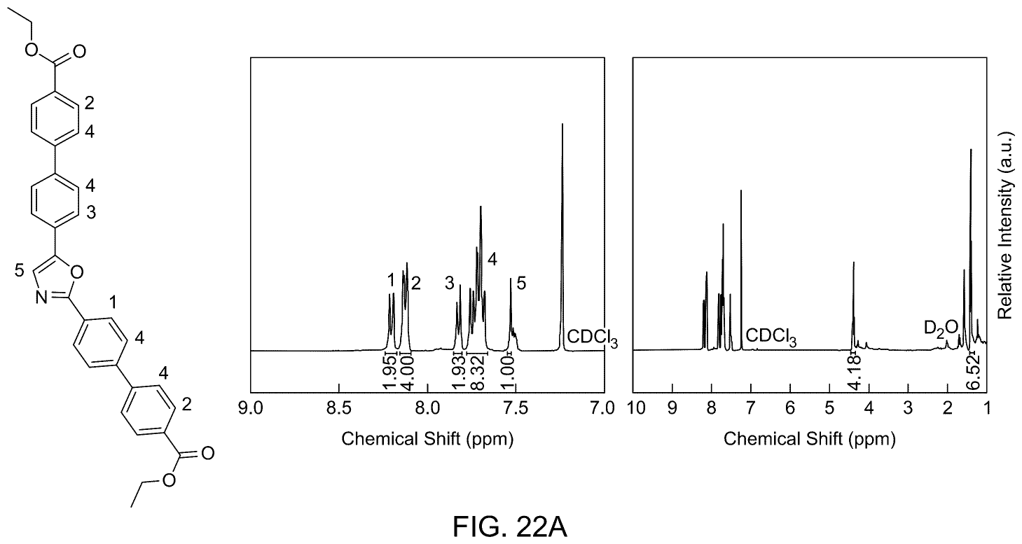

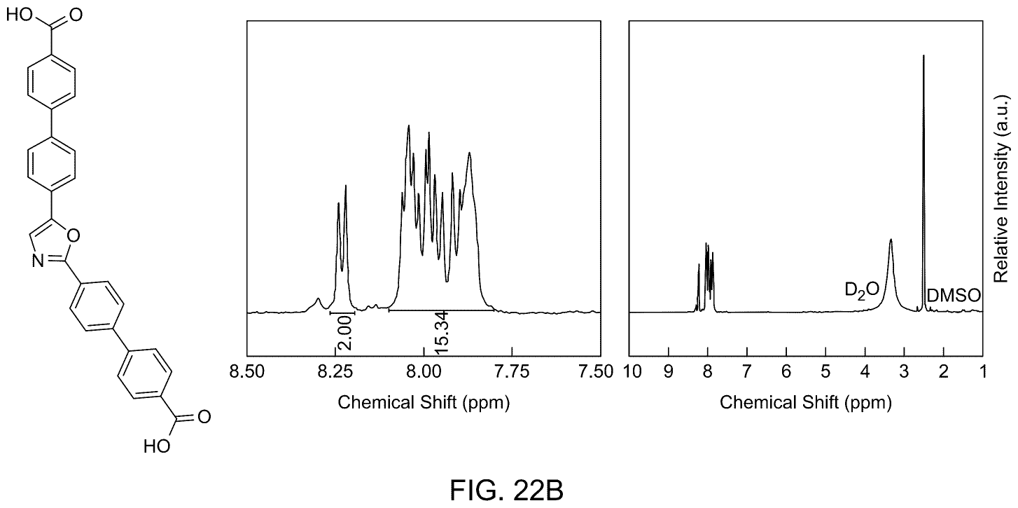

Referring to FIG. 22A, ¹H NMR spectra of 2,5-bis(4-carboxybiphenyl methyl ester 4′-yl)oxazole of formula (VIII) in CDCl₃-d. In some embodiments, the 2,5-bis(4-carboxybiphenyl methyl ester 4′-yl)oxazole of formula (VIII) has peaks in a range of 1 to 9, or more preferably about 1.43, about 4.42, about 7.55, about 7.74, about 7.85, about 8.145, and about 8.23 ppm, as depicted in FIG. 22A. Other ranges are also possible.

Referring to FIG. 22B, ¹H NMR spectra of 2,5-bis(4-carboxybiphenyl-4′-yl)oxazole of formula (III) in DMSO-d₆. In some embodiments, the 2,5-bis(4-carboxybiphenyl-4′-yl)oxazole of formula (III) has peaks in a range of 7.5 to 8.5, or more preferably about 7.75 to 8.1, and about 8.1 to 8.3 ppm, as depicted in FIG. 22B. Other ranges are also possible.

### Examples

The following examples demonstrate a metal-organic framework (MOF). The examples are provided solely for illustration and are not to be construed as limitations of the present disclosure, as many variations thereof are possible without departing from the spirit and scope of the present disclosure.

### Example 1: Materials

All chemicals were purchased from commercial suppliers and were used without any further purification or modification. 2,5-diphenyloxazole (99% purity), sulfuric acid (99% purity; H₂SO₄), nitric acid (69 wt. %; HNO₃), benzene (99% purity), tetrahydrofuran (99% purity; THF), ethanol (99% purity; EtOH), palladium on carbon (5 wt. % loading; Pd/C), Celite® (454 AW reagent grade; SiO₂), silica gel (60 Å, 70-230 mesh; SiO₂), sodium nitrite (98% purity; NaNO₂), potassium iodide (>95% purity; KI), sodium sulfite (99% purity; Na₂SO₃), chloroform (99% purity; CHCl₃), methanol (>99% purity; MeOH), N,N-Dimethylformamide (>99% purity; DMF), copper (II) sulfate (98% purity; Cu₂SO₄·xH₂O), sodium hydroxide (99% purity; NaOH), potassium cyanide (98% purity; KCN), ammonium hydroxide solution (28-30% w/w; NH₄OH (aq)), dichloromethane (>99% purity; DCM), hydrochloric acid (35 wt. %; HCl), indium (99.99% purity; In), sodium azide (≥99.5% purity; NaN₃), palladium (II) acetate (46.6-49.0% palladium (Pd) basis; Pd(CH₃COO)₂), cesium carbonate (99% purity; Cs₂CO₃), 4-ethoxycarbonylphenylboronic acid (≥95% purity), potassium Bromide (99% purity; KBr), glacial acetic acid (≥99% purity; CH₃COOH), isopropanol (≥99.5% purity; i-prOH), N-methyl-2-pyrrolidone (99.5% purity; NMP), anhydrous zirconium (IV) chloride (99% purity; ZrCl₄), titanium (IV) isopropoxide (97% purity; Ti[OCH(CH₃)₂]₄) copper (II) acetate monohydrate (98% purity; Cu(CH₃COO)₂·H₂O), copper (II) nitrate pentahydrate (98% purity; Cu(NO₃)₂·5H₂O), zinc (II) acetate dihydrate (98% purity; Zn(CH₃COO)₂·2H₂O), zinc (II) nitrate hexahydrate (98% purity; Zn(NO₃)₂·6H₂O).

### Example 2: Characterization Methods

¹H Nuclear Magnetic Resonance (NMR) and ¹³C NMR were carried out on a Bruker 400 MHz spectrometer (manufactured by Bruker, Billerica, Massachusetts, United States). Samples were loaded in thin-walled 5 mm diameter borosilicate tubes with polyethylene caps. Samples were dissolved in 0.6 mL of deuterated solvents, DMSO-d₆ or CDCl₃ as saturated solutions at a spin rate of 20 Hz. Peaks were specified as; s, singlet; d, doublet; m, multiplet; and br, broad. Fourier Transform Infrared (FT-IR) spectrograms were produced using KBr pellets and were analyzed by a PerkinElmer 16 PC spectrometer in the mid-IR range of 500-4000 cm⁻¹ (manufactured by Perkin Elmer, Massachusetts, United States). Powder X-ray Diffraction (PXRD) patterns were gained from the Rigaku MiniFlex II benchtop X-ray diffractometer, with X-ray radiation from Cu k_{α} (λ=1.541 Å) source (manufactured by Rigaku, Japan). Single Crystal X-ray Diffraction (SCXRD). A single crystal was solved on a Bruker AXS D8 Quest diffractometer with a microfocus sealed tube X-ray source Mo k_{α} (λ=0.71073 Å) (manufactured by Bruker, Billerica, Massachusetts, United States). Scanning Electron Microscopy (SEM) micrographs were captured on a Thermo Scientific Quattro Environmental SEM (ESEM) (manufactured by Thermo Fischer, United States). The electron gun was set at a working distance of 11.1 mm from the samples, and the electrons generated had an accelerating voltage of 5.0 kV and a current of 57 pA. Micrographs were obtained from the secondary electrons detected on Everhart-Thornley Detector (ETD). All samples were gold-coated for 20 seconds.

### Example 3: Synthesis of 2,5-bis(4-nitrophenyl)oxazole of Formula (IV)

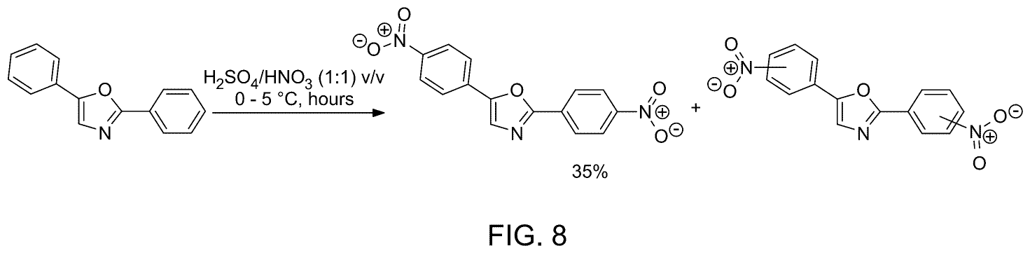

In a 100 mL round bottom flask, concentrated H₂SO₄ (10 mL) was added at room temperature. 2,5-diphenyloxazole (10.0 g, 45.2 mmol) was then added portion-wise until all solid dissolved and a highly viscous solution was formed. The flask was then introduced to an ice bath and kept under stirring to maintain the temperature between 0 and 5° C. A nitrating mixture of H₂SO₄ and HNO₃ in a 1:1 (v/v) ratio (10.0 mL:10.0 mL) was added to the solution by a dropping funnel, with an approximate rate of 5 drops/second. A clear yellow solution was formed upon the completion of the addition, and the solution was left to stir in the ice bath for 3 hours. The solution is then poured onto chopped ice in a 1 L beaker to form a bright yellow solid. To the beaker, 500 mL distilled water was added, and the mixture was stirred vigorously to disintegrate the chunks of solid and remove the residual acid. The solid was filtrated and washed several times with distilled water until the filtrate reached a pH of 6-7. Finally, the solid was stirred in acetone (400 mL) to remove a major quantity of undesired regioisomers, then filtered and dried at 100° C. under a vacuum for 12 hours. The crude product (13.4 g) was purified by successive recrystallization from hot acetone. Single crystals of this compound were collected and studied; the best crystals were obtained by recrystallization from benzene (FIG. 8).

The solid was suspended in 500 mL of benzene and heated up to boiling, then filtered while hot to remove any insoluble residue, then covered and left still at room temperature to crystallize. The crystals were washed with cold benzene and recrystallized again in the same way. After the second crystallization, the yellow crystals were harvested and dried (100° C. for 12 hours) to yield the final pure product (4.91 g, 15.8 mmol, 35%). ¹H NMR (400 MHZ, DMSO-d₆) δ 8.16 (m, 2H), 8.27 (s, 1H), 8.37 (m, 4H), 8.41 (m, 2H) (FIG. 16A). ¹³C NMR (400 MHZ, DMSO-d₆) δ 124.56, 124.57, 125.27, 127.51, 128.60, 131.70, 132.85, 147.03, 148.58, 150.25, 159.89 (FIG. 16B).

### Example 4: Synthesis of 2,5-bis(4-aminophenyl)oxazole of Formula (V)

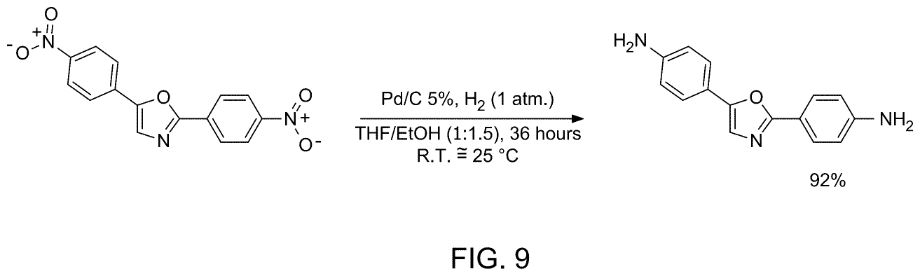

In a 250 mL round bottom flask, (2.0 g, 6.4 mmol) of IV were added along with 5 wt. % Pd/C (150 mg, 0.07 mmol of Pd). The flask was sealed with a rubber septum and evacuated for 10 minutes. THF/EtOH mixture (30 mL/50 mL) was added to the evacuated system with a syringe, then a hydrogen balloon was inserted through the septum and left connected throughout the reaction period (36 hours). The balloon was refilled when needed to avoid any possible air leakage into the system. After a few hours, the yellow solid of (IV) disappears, and upon the completion of the reaction, the only solid inside the solution is the Pd/C, and the solution becomes clear and almost colorless. The reaction mixture is then filtered over celite to remove the Pd/C catalyst, and the filtrate is evaporated using a rotary evaporator to get the solid product (1.48 g, 5.9 mmol, 92%). The amine compounds may change color with air exposure or with different solvents, and a range of colors from pale brown to red was observed from different patches of synthesizing this compound (FIG. 9).

¹H NMR (400 MHZ, DMSO-d₆) δ 5.42 (br, 2H), 5.67 (br, 2H), 6.65 (m, 4H), 7.28 (s, 1H), 7.42 (d, 2H), 7.69 (d, 2H) (FIG. 17A). ¹³C NMR (400 MHZ, DMSO-d₆) δ 114.0, 114.4, 115.0, 116.0, 120.2, 125.4, 127.5, 149.4, 150.8, 151.2, 160.3 (FIG. 17B).

### Example 5: Synthesis of 2,5-bis(4-iodophenyl)oxazole of formula (VI)

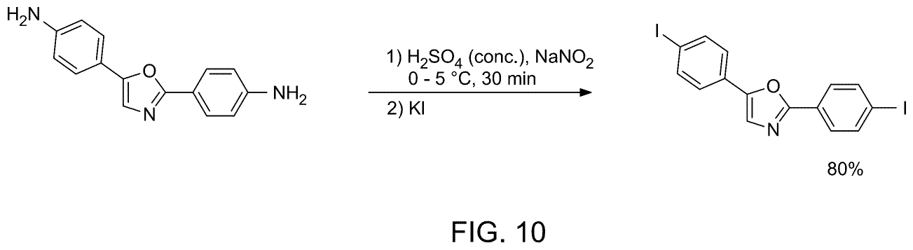

In a 250-round bottom flask, H₂SO₄ (34 mL) was added at room temperature, followed by portion-wise addition of compound V (2.0 g, 7.96 mmol). The mixture was left stirring until all solids dissolved, and then the flask was immersed in an ice bath with continuous stirring. After 10 minutes, NaNO₂ (4.4 g, 63.7 mmol) was added portion-wise to the solution to form the diazonium salt, and the solution was left stirring for another 10 minutes, maintain the temperature of the ice bath lower than 10° C., preferably lower than 5° C. Before adding KI, a small amount of crushed ice was added to the mixture, then KI (13.2 g, 79.6 mmol) was ground to a fine powder and then added portion-wise to the reaction mixture. At this point, mechanical stirring with a glass rod will be needed, as upon the addition of KI, the mixture becomes highly viscous with the product forms along with condensation of some solid iodine. Every couple of minutes, a small amount of crushed ice was added to assure the stability of the temperature at desired. The reaction was left stirring at room temperature overnight, and then the excess iodine was quenched by the addition of Na₂SO₃ (22.0 g in 100 ml distilled water) until the color changed from black to light brown or yellowish-orange. The solid was then filtered and washed several times with water to remove any residual acid. The filtered solid was extracted with chloroform (3×250 mL, Soxhlet extraction is valid), and the chloroform solution was washed with a Na₂SO₃, then brine solution in a separatory funnel, dried over MgSO₄, and finally, after evaporating, the chloroform, the solid was purified with column chromatography (with DCM) to get the solid product (3.0 g, 6.3 mmol, 79.7%) (FIG. 10).

¹H NMR (400 MHZ, DMSO-d₆) δ 7.66 (d, 2H), 7.88 (m, 4H), 7.94 (d, 2H), 7.96 (s, 1H) (FIG. 18A). ¹³C NMR (400 MHZ, DMSO-d₆) δ 94.97, 98.05, 125.14, 126.01, 126.76, 127.79, 137.90, 138.07, 150.26, 159.90 (FIG. 18B).

### Example 6: Synthesis of 2,5-bis(4-cyanophenyl)oxazole of formula (VII)

Preparation of CuCN: In a 50 mL round bottom flask, CuSO₄ (3.75 g, 15 mmol) was dissolved in distilled water (9.0 mL) heated at about 45° C. An aqueous solution of Na₂SO₃ (0.95 g, 7.5 mmol in 5.0 ml distilled H₂O) was poured onto the CuSO₄ solution. A separate solution of KCN (0.78 g, 12 mmol) and KOH (0.35 g, 6.1 mmol) in 4.0 ml distilled H₂O was prepared and was added drop by drop to the reaction mixture (approximately 1 drop every 5 seconds). Upon the addition, the reddish-brown precipitate that formed earlier started to disappear, and near the end of the addition, the gray-white precipitate of the product started to form. The reaction was left stirring for 1 hour at about 45° C. and then for about another 30 minutes at room temperature. The solid was filtered, and washed in a sequence with distilled H₂O, EtOH, and finally Et₂O. The final product was dried at room temperature under reduced pressure.

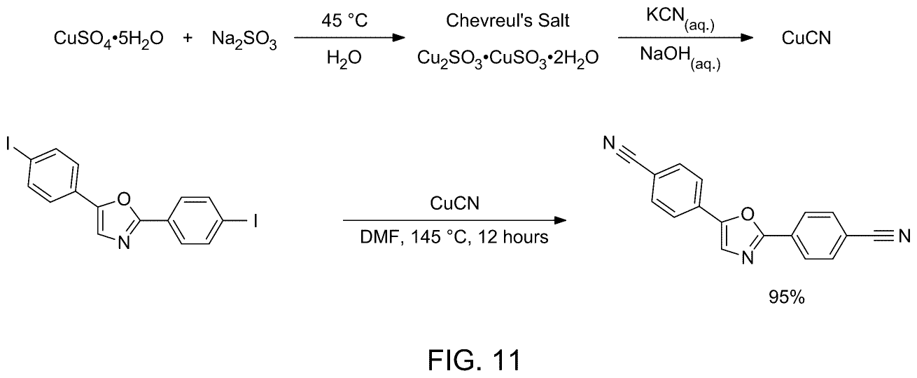

Preparation of compound (VII): In a 250 mL round bottom flask, compound VI (2.0 g, 4.23 mmol) and CuCN (1.5 g, 16.9 mmol) were added, and the flask was sealed with a rubber septum and evacuated. Dry DMF (65.0 mL) was added with a syringe, and the flask was filled with nitrogen gas. The flask was introduced to a preheated oil bath at about 145° C. while connected to a reflux system under inert conditions and kept stirring for about 12 hours. Once the reaction was complete, the reaction mixture was filtered, and the solid was washed with DMF. The filtrate was then dried on a rotary evaporator to get the crude solid product. The solid was stirred in an ammonium hydroxide solution and then filtered; the process was repeated until no blue color was observed. Finally, the solid was further purified with filtration through a silica plug (with DCM), and the product was isolated as an off-white solid (1.1 g, 4.05 mmol, 95%) (FIG. 11).

¹H NMR (400 MHZ, DMSO-d₆) δ 8.00 (d, 2H), 8.06 (d, 2H), 8.10 (d, 2H), 8.20 (s, 1H), 8.31 (d, 2H). ¹H NMR (400 MHZ, CDCl₃) δ 7.66 (s, 1H), 7.81 (m, 6H), 8.23 (d, 2H) (FIG. 19A). ¹³C NMR (400 MHZ, DMSO-d₆) δ 111.4, 113.5, 118.8, 119.1, 125.4, 127.4, 128.2, 130.6, 131.6, 133.6, 133.7, 150.7, 160.3 (FIG. 19B).

### Example 7: Synthesis of 2,5-bis(4-carboxyphenyl)oxazole of formula (I)

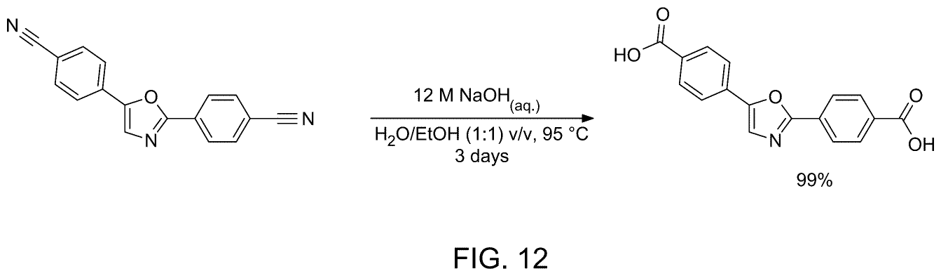

In a 100 mL round bottom flask, compound VII (1.0 g, 3.69 mmol), EtOH (18.0 mL), and 12 M NaOH (aq.) (8.6 g, 225 mmol in 18.0 mL distilled H₂O) were added together forming two layers. The mixture was refluxed at 95° C. for three days. After the indicated time, the formed solid was filtered and washed several times with EtOH, then left to dry in air for about 1 hour. The dried solid was then dissolved in distilled H₂O, and the solution was filtered to remove any insoluble impurities. The filtrate was then acidified with concentrated HCl until pH less than 4, preferably less than 3, or even more preferably less than 2 was achieved to precipitate the acid form of the product. The formed solid was filtered and washed several times with distilled H₂O to remove any residual acid. Finally, the solid was dried at 60° C. to obtain the final product (1.1 g, 3.56 mmol, 99%) (FIG. 12).

¹H NMR (400 MHz, DMSO-d₆) δ 8.01 (d, 2H), 8.07 (d, 2H), 8.08 (s, 1H), 8.12 (d, 2H), 8.24 (d, 2H), 13.2 (br, 2H) (FIG. 20A). ¹³C NMR (400 MHZ, DMSO-d₆) δ 124.6, 126.7, 127.0, 130.5, 130.6, 131.0, 131.4, 133.0, 151.0, 160.6, 167.2, 167.3 (FIG. 20B).

### Example 8: Synthesis of 2,5-bis(4-(1H-tetrazole-5-yl)phenyl)oxazole of formula (II)

Preparation of InCl₃: In a 500 mL round bottom flask, metallic indium (11.5 g, 0.10 mol) and concentrated HCl (50.0 mL, 0.58 mol) were mixed and stirred at about 45° C. until all metal was dissolved, showing the formation of hydrated indium (III) chloride. The flask was then connected to a distillation system, and the HCl solution was distilled with purging air to dryness. To the formed solid, butanol (245 mL) was added as a dewatering agent, and the mixture was stirred for 15 minutes at reflux (about 100° C.), then distilled under N₂ atmosphere at 180° C. to dryness to yield the final product as an anhydrous indium (III) chloride.

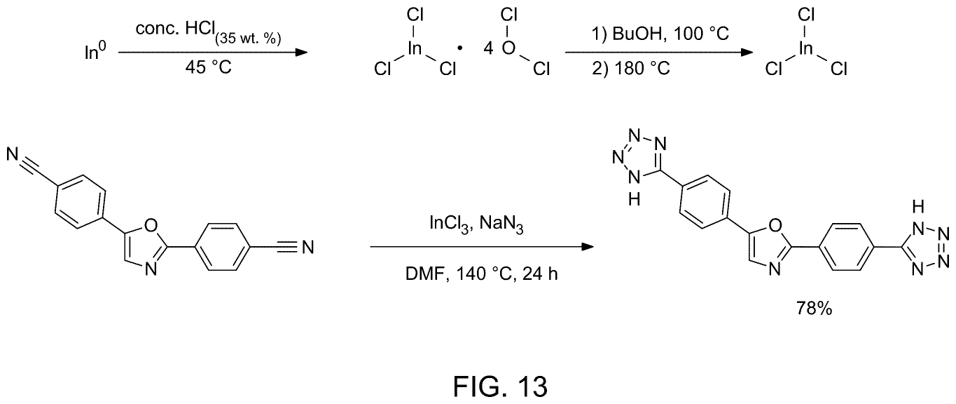

Preparation of compound (II): In a 50 mL round bottom flask, compound (VII) (0.30 g, 1.11 mmol) was suspended in anhydrous DMF (10 mL) at room temperature. To the suspension, NaN₃ (0.36 g, 5.55 mmol) and InCl₃ (0.05 g, 0.22 mmol (20 mol % of compound (VII))) were added, and the mixture was introduced to a pre-heated oil bath to reflux at about 140° C. for two days. After the specified time elapses, the mixture is left to cool to room temperature, then poured into distilled water and acidified with conc. HCl to pH less than 3, preferably less 2, or even more preferably less than 1. The solid was filtered, and the final product was isolated as a faint yellow solid (0.31 g, 0.86 mmol, 78%) (FIG. 13).

¹H NMR (400 MHZ, DMSO-d₆) δ 8.09 (s, 1H), 8.13 (d, 2H), 8.19 (d, 2H), 8.25 (d, 2H), 8.36 (d, 2H) (FIG. 21A). ¹³C NMR (400 MHZ, DMSO-d₆) as depicted in FIG. 21B.

### Example 9: Synthesis of 2,5-bis(4-carboxybiphenyl methyl ester 4′-yl)oxazole of formula (VIII)

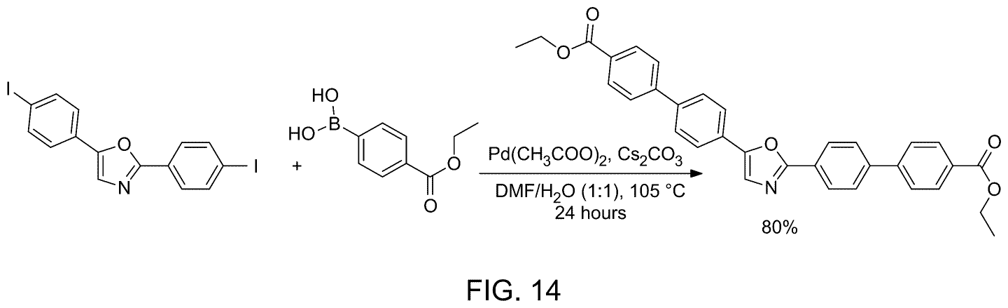

In a 100 mL round bottom flask, DMF (15 mL) and distilled water (15 mL) were mixed, and the flask was sealed with a rubber septum. The flask was placed in a sonicator while nitrogen gas bubbled through the mixture with a nitrogen-filled balloon for about 20 minutes to ensure degassing of any dissolved oxygen. 2,5-bis(4-iodophenyl)oxazole of formula (VI) (500 mg, 1.06 mmol), 4-ethoxy carbonyl phenylboronic acid (823 mg, 4.24 mmol), CsCO₃ (1.55 g, 4.77 mmol), and Pd(CH₃COO)₂ (2.0 mg, 0.01 mmol, 0.85 mole % of compound (VI)) were all added in sequence to the solvent mixture. The mixture was immediately transferred to a preheated oil bath at about 105° C. and kept under continuous stirring for about 24 hours. Once complete, the flask was left to cool to room temperature, then the mixture was filtered. The solid was used for the next step without any further purification (FIG. 14).

¹H NMR (400 MHZ, CDCl₃) δ 1.43 (t, 6H), 4.42 (q, 4H), 7.55 (s, 1H), 7.74 (m, 8H), 7.85 (d, 2H), 8.145 (dd, 4H), 8.23 (d, 2H) (FIG. 22A).

### Example 10: Synthesis of 2,5-bis(4-carboxybiphenyl-4′-yl)oxazole of formula (III)

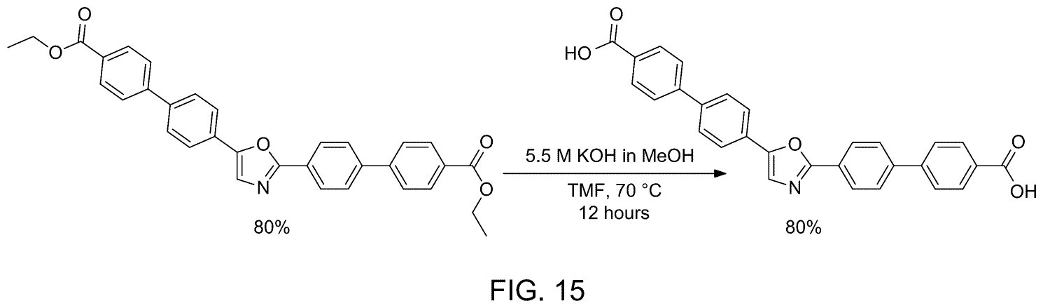

In a 100 mL round bottom flask, compound (VIII) (0.40 g, 0.77 mmol) was suspended in THF (20 mL). To the suspension, about 20 mL of 5.5 M KOH solution (6.17 g, 0.11 mol in MeOH) was added, and the mixture was refluxed at about 70° C. for about 12 hours. After completion, the reaction was left to cool to room temperature; then, the solid was separated with centrifugation. The isolated solid was then dissolved in a large quantity of hot water, and the mixture was filtered to remove any insoluble material. The filtrate was acidified with HCl until a pH of 1 to 4, or even more preferably 1-2 was achieved, and the precipitate was collected and washed several times to ensure the removal of any residual acid. Finally, the product was dried in an oven at about 80° C. for about 12 hours to afford the product (III) (0.29 g, 0.62 mmol, 80%) (FIG. 15).

¹H NMR (400 MHZ, DMSO-d₆) δ 7.97 (m, 15H), 8.23 (d, 2H) (FIG. 22B).

### Example 11: Characterization by Nuclear Magnetic Resonance Spectroscopy (NMR)

FIG. 16A shows the peak positions obtained from compound (IV). Starting with the 1H NMR, the single proton located on the oxazole ring, proton number (4), is the most distinct one, as it usually comes out as a single peak. Apart from proton number (4), there are two other sets of peaks; protons (5) were assigned to the more shielded set, as the benzene ring is less affected by the electron-withdrawing effect imposed by the oxazole group. The remaining protons were assigned to the less shielded set, as all of the protons are adjacent to electron-withdrawing groups, either the nitro or the oxazole groups. The integration of the peaks, nine protons, was enough to ensure that only two nitro groups were substituted on the benzene rings during the nitration. The different electronic environments between the two benzene rings resulted in a relatively complicated spectrum that might be considered as a 2^{nd} order spectrum from which determining the regioisomer that was formed is a tedious task. Since the purification of the compound was carried out through crystallization, proof of the structure was provided by SCXRD.

¹³C NMR proves the electronic inequivalence between the aromatic rings by showing eleven different carbon chemical shifts corresponding to all the carbons in the structure, except for the remaining four carbons that have chemically equivalent ones on each side of the benzene rings around the axis of connection (FIG. 16B).

In FIG. 17A, it shows all the peaks have shifted upfield back to a lower chemical shift. Unlike nitro groups, the amino groups are electron donating, providing the aromatic system with more electrons and hence more shielding because of the opposing magnetic field produced by this electron density. The oxazole group is considered an electron-withdrawing group, and since now the system has both electron-donating and electron-withdrawing groups at different benzene rings, there's much better separation of the peaks compared to what was witnessed with compound (IV). At 5.42 and 5.67 ppm, two broad peaks are observed, each worth two protons; these two protons are assigned to the amino groups, the less shielded one being assigned to the group on the benzene ring adjacent to the oxazole heteroatoms. The four protons at 6.65 ppm are affected by the amino groups, which are in close proximity to each other, although not identical or showing doublet of doublet splitting because of the effect of the oxazole ring on one of the rings.

In FIG. 18A, it was shown that as the electron-donating amino groups were substituted with the halogen, all the protons fell in a very narrow region of chemical shifts. In ¹³C NMR, ten different peaks were recognized. Peaks at 150.26 ppm (2) and 159.90 ppm (1) are the characteristic quaternary carbons within the oxazole ring, while the peaks below 100 ppm at 94.97 (10) and 98.05 (9) are assigned to the quaternary carbons bound to the iodine atoms. The missing peak is possibly overlapped with peak number (7) as it shows higher broadening with closer examination (FIG. 18B).

Referring to FIGS. 19A, the 9 protons of the compound (VII) can be seen, with 4 peaks of integration (2H) appearing as doublets of doublets and a singlet with integration (1H) for the proton in the oxazole ring. This spectral pattern can only be obtained from para-substituted phenylene rings, showing the high purity of the obtained product (FIG. 19A). In this compound, as there are two more carbon atoms added to the structure with the nitrile groups, the ¹³C NMR spectrum shows a complete set of 13 carbons as expected theoretically, proving the exchange of the iodine atoms with the nitrile group on both the reaction sites (FIG. 19B).

In FIG. 20A, it can be seen from the spectrogram that the product (I) was obtained in high purity, and the characteristic peak for the carboxylic acid is shown at 13.2 ppm with integration reflecting the presence of two carboxylic protons. Also, the ¹³C NMR spectrogram of FIG. 20B, shows the carboxylic carbons located at very close positions at 167.2 and 167.3 ppm (FIG. 20B). This is evidence for the hydrolysis of the nitrile derivative, compound (VII), into the dicarboxylic acid derivative, compound (I). The spectrogram showed that the electron-withdrawing effect of the carboxylic acid groups is relatively similar to that of the oxazole ring, as now all the aromatic proton peaks are located in very close vicinity to each other, between 8.01 and 8.24 ppm. Although two carbon atoms were added to the structure and were spotted at two adjacent positions, only 12 carbons in the ¹³C NMR spectrum were observed instead of 13. This can be attributed to the carbon type to an overlap between the carbons located at position (8), at 130.6 ppm, based on the fact that the ortho-positions with respect to the carboxylic acids will be prone to a similar electron-deficient environment, and the significant increase in intensity relative to the intensities of the remaining peaks.

### Example 12: Characterization by Fourier Transform Infrared Spectroscopy (FT-IR)

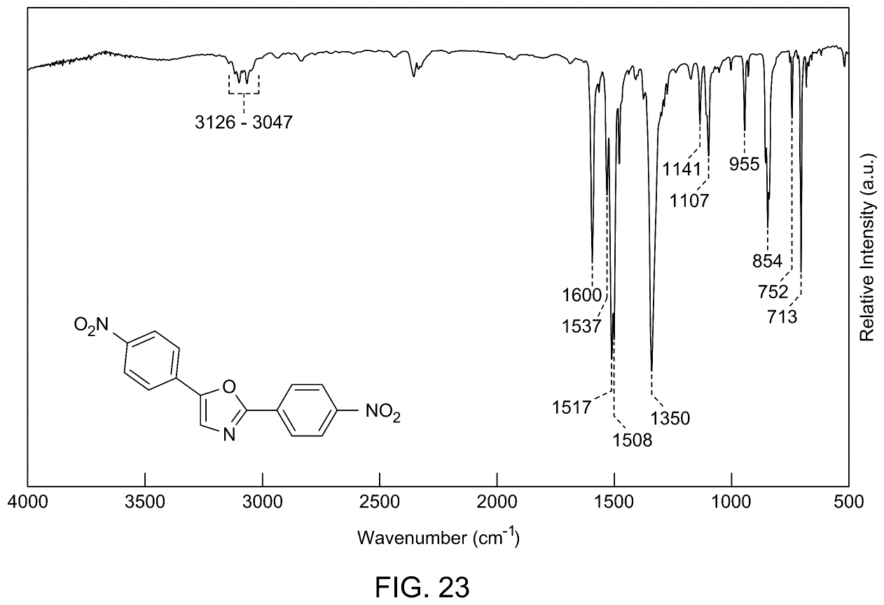

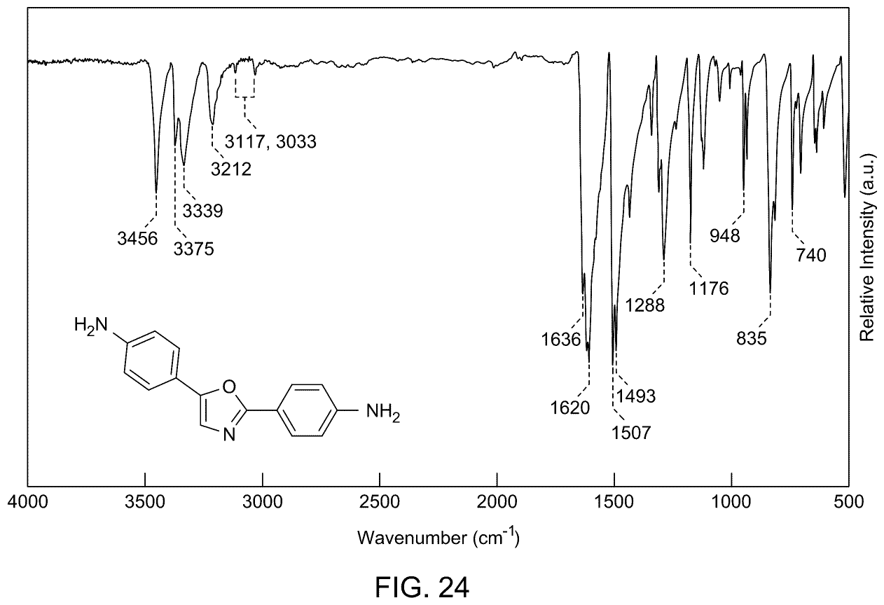

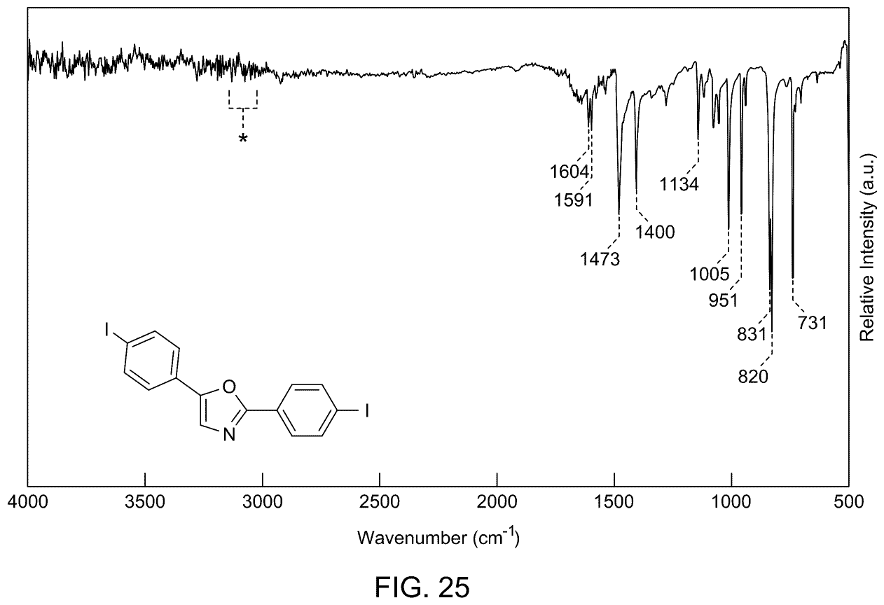

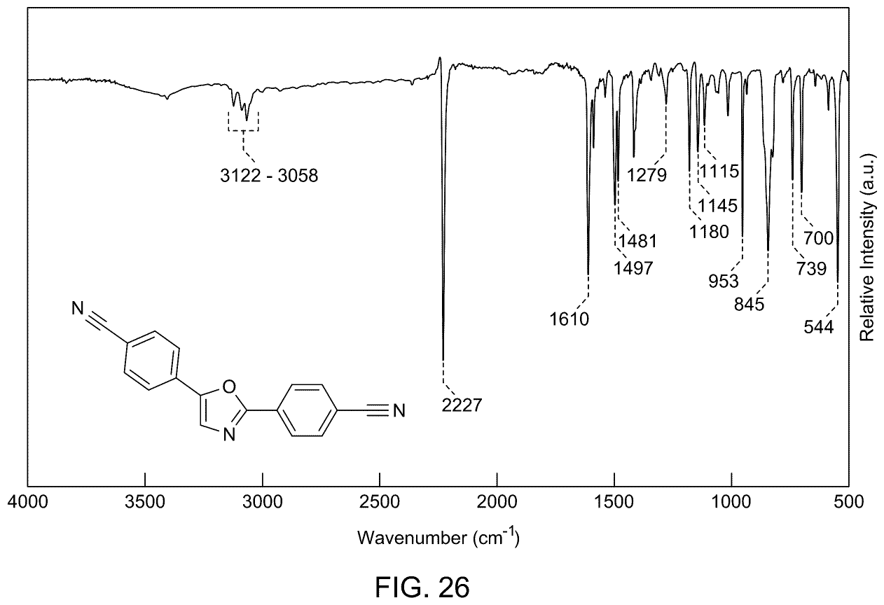

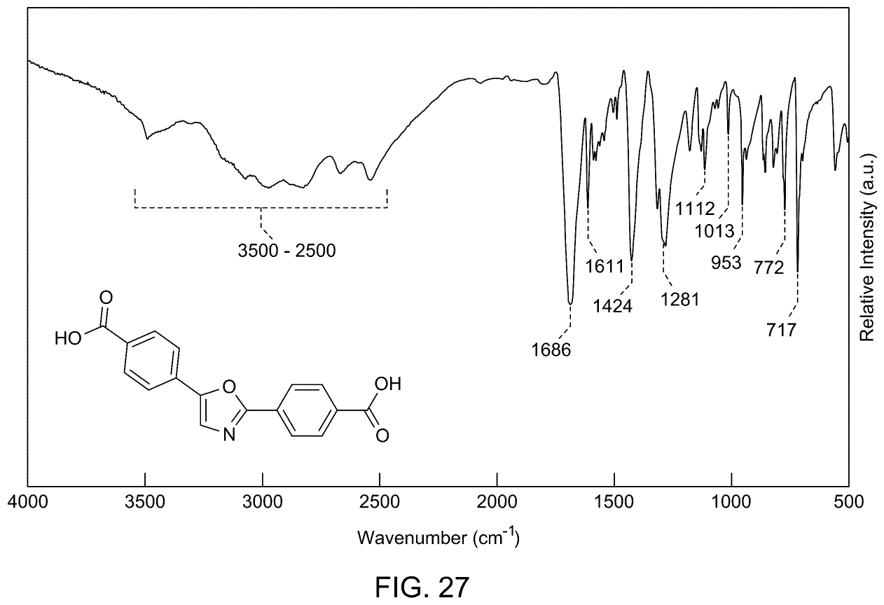

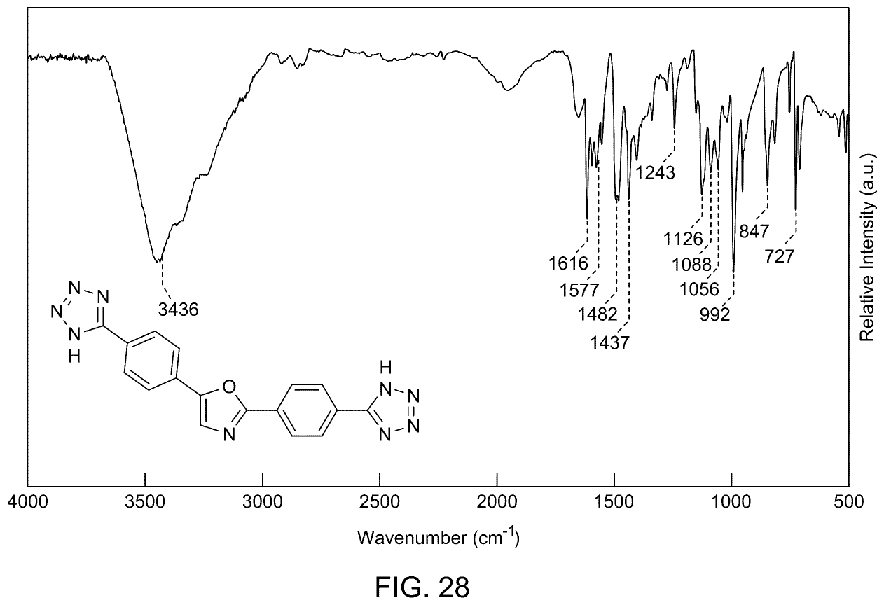

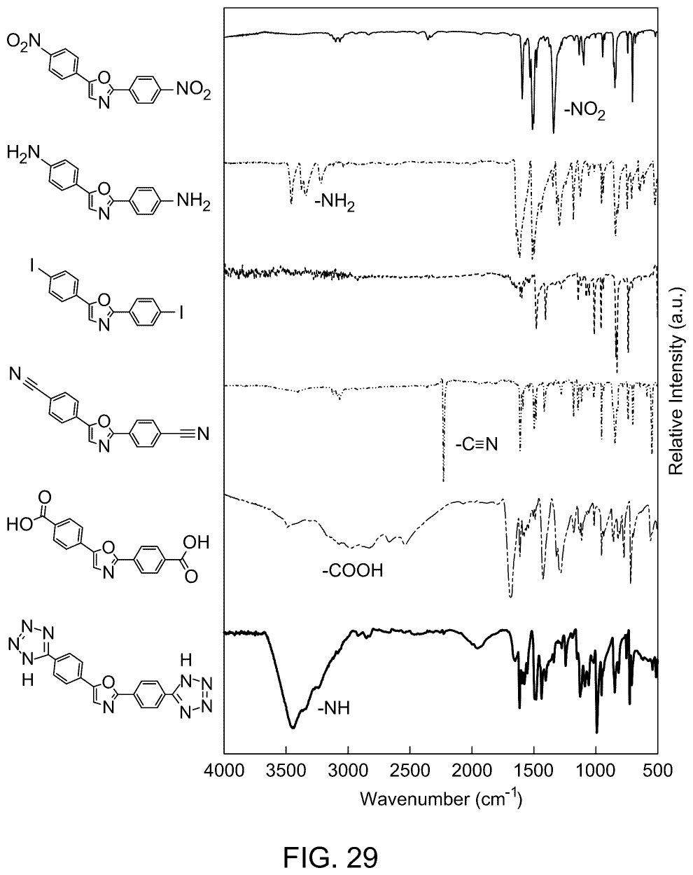

Organic transformations are happening on an unaffected core unit, 2,5-diphenyloxazole, with maintained construction. The variable in these transformations is the functional group, which also maintains its regioselectivity throughout the reactions. FT-IR was used to characterize these compounds, as it fundamentally differentiates compounds based on the difference between the absorption energies of various functional groups. The characterization of the compounds (I-VIII) using FT-IR spectroscopy was performed by identifying the characteristic bands by energy, shape, and intensity and comparing the spectra obtained from all the compounds to clarify the formation of the intended products' bands and the disappearance of old ones. The FT-IR spectra of compounds (IV), (V), (VI), (VII), (I), and (II) are depicted in FIG. 23 to FIG. 28, respectively. FIG. 29 shows an all-in-one stacked comparison of all FTIR spectra for compounds (IV-V, I and II), showing the most characteristic band of the functional groups in each compound.

TABLE 1
Extracted FT-IR band positions and descriptions of compound (IV)

| Band Position | Band Description & Possible Assignment |
|---|---|
| 3126-3047 | Aromatic H—C (sp²) bond stretching - weak |
| 1600 | C═C (in ring) - strong |
| 1537 | Medium |
| 1517 & 1350 | Nitro groups symmetric & asymmetric stretching - strong |
| 1508 | Weak |
| 1141 | Weak |
| 1107 | Weak |
| 955 | Weak |
| 854 | Medium |
| 752 | Weak |
| 713 | Strong |

TABLE 2
Extracted FT-IR band positions and descriptions of compound (V)

| Band Position | Band Description & Possible Assignment |
|---|---|
| 3456 & 3375 | N—H stretches of primary amines - medium |
| 3339 & 3212 | Shoulder bands |
| 3117 & 3033 | Aromatic H—C (sp²) bond stretching - weak |
| 1636 | C═C (in ring) - strong |
| 1620 | N—H bending of primary amines - strong |
| 1507 | Weak |
| 1493 | Weak |
| 1288 | C—N Stretching - medium |
| 1176 | Medium |
| 948 | Weak |
| 835 | Medium |
| 740 | N—H wagging of primary amines - medium |

TABLE 3
Extracted FT-IR band positions and descriptions of compound (VI)

| Band Position | Band Description & Possible Assignment |
|---|---|
| 1604 | C═C (in ring) - weak |
| 1591 | Weak |
| 1473 | Medium |
| 1400 | Medium |
| 1134 | Weak |
| 1005 | Medium |
| 951 | medium |
| 831 | Strong |
| 820 | Strong |
| 731 | Strong |

* The aromatic C(sp²)—H bond stretching is believed to be lost within the instrumental noise

TABLE 4
Extracted FT-IR band positions and descriptions of compound (VII)

| Band Position | Band Description & Possible Assignment |
|---|---|
| 3122-3058 | Aromatic H—C (sp²) bond stretching - weak |
| 2227 | C≡N bond stretching - strong |
| 1610 | C═C (in ring) - strong |
| 1481, 1497 | medium |
| 1279 | Weak |
| 1115 | medium |
| 1145 | medium |
| 1180 | Weak |
| 953 | Strong |
| 845 | Strong |
| 739 | medium |
| 700 | medium |
| 544 | Strong |

TABLE 5
Extracted FT-IR band positions and descriptions of compound (I).

| Band Position | Band Description & Possible Assignment |
|---|---|
| 3500-2500 | Carboxylic acid O—H bond stretching - medium broad |
| 1686 | C═O bond stretching - strong |
| 1611 | C═C (in ring) - medium |
| 1424 | O—H bending - strong |
| 1281 | C—O stretching - medium |
| 1112 | Weak |
| 1013 | Weak |
| 953 | O—H bending - medium |
| 772 | Medium |
| 717 | Strong |

TABLE 6
Extracted FT-IR band positions and descriptions of compound (II)

| Band Position | Band Description & Possible Assignment |
|---|---|
| 3436 | —N—H stretching of secondary |
| | amine - broad strong |
| 1616 | —C═C— (in ring) - medium |
| 1577 | Tetrazole ring stretching - medium |
| 1482 | Medium |
| 1437 | Medium |
| 1243 | —N—N═N— - weak |
| 1126, 1088 & 1056 | Tetrazole ring breathing vibrations - medium |
| 992 | Strong |
| 847 | Medium |
| 727 | Medium |

### Example 13: MOF Synthesis

In a typical synthesis, the organic linker, compound (I), is added in a 20 mL Pyrex vial, then DMF is added, and the mixture is sonicated until a clear solution is achieved. Another solvent(s) is (are) added to the clear solution, followed by the metal precursor. Finally, the modulator is added, and the vial is capped and sonicated for 5 min before incubating in a preheated oven at the desired temperature. The crystals formed are harvested from the mother liquor and are washed several times with DMF to ensure the removal of any residual starting materials. The crystals are washed with MeOH to exchange the DMF within the framework to ensure efficient activation. Finally, crystals are dried under vacuum at room temperature. The formed crystalline solid resulting from all the reactions was tested for solubility in DMF to ensure that the recrystallization of starting materials did not occur and that an insoluble extended product was formed. Then the PXRD patterns for the solids were investigated and compared with that of the organic linker. All the formed solids showed diffraction peaks at low two theta angles, which indicates large d spacing and large pores within an extended structure, as concluded from Bragg's equation (FIG. 30).

SEM micrographs shown below were captured from the two samples, 138-14 (FIGS. 31A-31B) and 138-15 (FIGS. 31C-31D). Sample 138-14 shows a pure phase material with a noticeable heterogeneity in particle sizes ranging from approximately 5 to 40 μm. Additionally, a modulator, a monocarboxylate acid was used, to compete with the organic linker, lower the reaction rate and consequently increase the crystal sizes. A much larger and more homogeneous particles were achieved. The identity of both samples was proven to be identified through the PXRD pattern.

A series of oxazole-based carboxylate and tetrazole bifunctional linkers, and their methods of making are provided in the present disclosure. The prepared linker structures were characterized using various spectroscopic techniques such as ¹H and ¹³C solution nuclear magnetic resonance (NMR) and Fourier Transform Infrared Spectroscopy (FT-IR). The synthesis of Zn-based MOF from the dicarboxylic acid diphenyl oxazole has been achieved. The MOF-based linkers of the present disclosure showed unreported and enhanced properties for the design and synthesis of functional porous materials, which paved the way for creating MOF materials with desired functionalities for the desired applications.

Numerous modifications and variations of the present disclosure are possible in light of the above teachings. It is therefore to be understood that within the scope of the appended claims, the invention may be practiced otherwise than as specifically described herein.

1: A metal-organic framework (MOF), comprising:
one or more metal ions; and
one or more oxazole-based organic linkers;
wherein each of the one or more oxazole-based organic linkers comprises an oxazole core substituted with two or more substituted aromatic rings;
wherein the one or more metal ions are linked to the one or more oxazole-based organic linkers through a nitrogen atom of the oxazole core; and
wherein the MOF has a cross-linked porous reticular structure comprising a plurality of extended tripodal and polyhedral units, wherein the MOF is in the form of particles having a particle size in a longest dimension of 5 to 40 μm.

2: The MOF of claim 1, having a diamondoid framework comprising the one or more metal ions bridged by the one or more of the oxazole-based organic linkers.

3: The MOF of claim 1, wherein the one or more metal ions are selected from the group consisting of zirconium, zinc, titanium, copper, nickel, cobalt, and iron.

4: The MOF of claim 1, wherein the one or more oxazole-based organic linkers are selected from the group consisting of 2,5-bis(4-carboxyphenyl)oxazole of formula [I], 2,5-bis(4-(1H-tetrazole-5-yl)phenyl)oxazole of formula [II], and 2,5-bis(4-carboxybiphenyl-4′-yl)oxazole of formula [III];

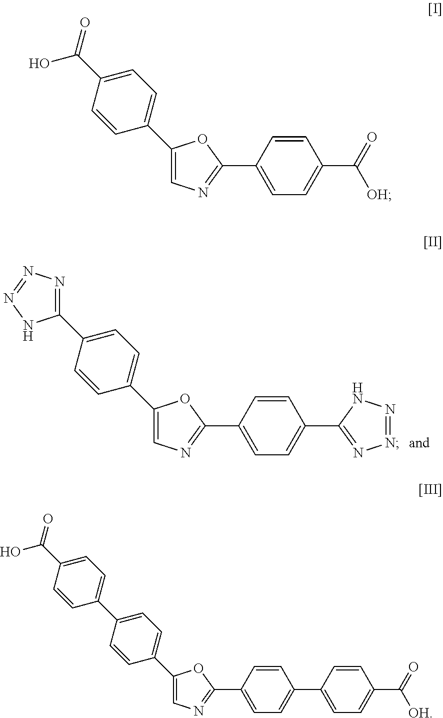 [SMILES: O=C(O)c1ccc(-c2cnc(-c3ccc(C(=O)O)cc3)o2)cc1 ; c1cc(-c2cnc(-c3ccc(-c4nnn[nH]4)cc3)o2)ccc1-c1nnn[nH]1 ; "and" ; O=C(O)c1ccc(-c2ccc(-c3cnc(-c4ccc(-c5ccc(C(=O)O)cc5)cc4)o3)cc2)cc1]

5: The MOF of claim 1, wherein the two or more substituted aromatic rings define planes that are substantially parallel with each other.

6: A method of making the MOF of claim 1, comprising:
mixing and dissolving the oxazole-based organic linker in dimethylformamide (DMF) to form a solution;
mixing a metal precursor, a monocarboxylate acid, and the solution to form a mixture; and
heating the mixture to form a precipitate; and
separating the precipitate from the mixture, washing and drying to form the MOF.

7: The method of claim 6, wherein the metal precursor is at least one selected from the group consisting of a zirconium salt, a zinc salt, a titanium salt, a copper salt, a nickel salt, a cobalt salt, and an iron salt.

8: The method of claim 6, wherein the monocarboxylate acid is acetic acid.

9: The method of claim 6, wherein the metal precursor is present in the mixture at a concentration in a range of 0.05-0.5 M.

10: The method of claim 6, wherein a molar ratio of the metal precursor to the oxazole-based organic linker in the mixture is in a range of 5:1 to 1:5.

11: The method of claim 6, further comprising:
preparing the oxazole-based organic linker by:
nitrating 2,5-diphenyloxazole in the presence of sulfuric acid and nitric acid to produce a nitrated crude product; and
purifying the nitrated crude product by recrystallizing to form a 2,5-bis(4-nitrophenyl)oxazole of formula [IV]; 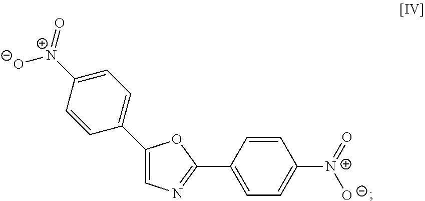
reducing the 2,5-bis(4-nitrophenyl)oxazole in the presence of a first palladium catalyst and a hydrogen gas to produce a 2,5-bis(4-aminophenyl)oxazole of formula (V); 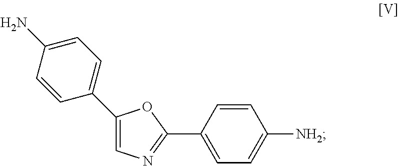 [SMILES: Nc1ccc(-c2cnc(-c3ccc(N)cc3)o2)cc1]
iodinating the 2,5-bis(4-aminophenyl)oxazole in the presence of a nitrite salt, and an iodide salt to produce a 2,5-bis(4-iodophenyl)oxazole of formula (VI); 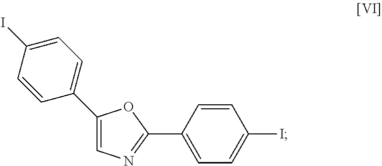 [SMILES: Ic1ccc(-c2cnc(-c3ccc(I)cc3)o2)cc1]
and
cyaniding the 2,5-bis(4-iodophenyl)oxazole in the presence of a cyanide salt to produce a 2,5-bis(4-cyanophenyl)oxazole of formula (VII);

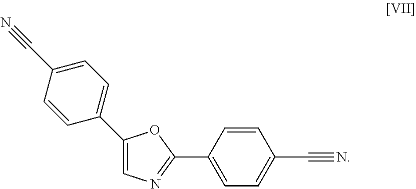 [SMILES: N#Cc1ccc(-c2cnc(-c3ccc(C#N)cc3)o2)cc1]

12: The method of claim 11, wherein the first palladium catalyst is a palladium/carbon catalyst having a palladium concentration of about 5 wt. % based on a total weight of the palladium/carbon catalyst.

13: The method of claim 11, wherein the nitrite salt is at least one selected from the group consisting of sodium nitrite, and potassium nitrite.

14: The method of claim 11, further comprising:
preparing the 2,5-bis(4-carboxyphenyl)oxazole of formula (I) by:
hydrolyzing the 2,5-bis(4-cyanophenyl)oxazole in the presence of a base at a temperature of about 90 to 100° C.

15: The method of claim 14, wherein the base is at least one selected from the group consisting of lithium hydroxide, sodium hydroxide, potassium hydroxide, and calcium hydroxide.

16: The method of claim 11, further comprising:
preparing the 2,5-bis(4-(1H-tetrazole-5-yl)phenyl)oxazole of formula (II) by:
reacting the 2,5-bis(4-cyanophenyl)oxazole and an azide compound in the presence of an indium salt by a cycloaddition reaction at a temperature of about 130 to 150° C.

17: The method of claim 16, wherein the azide compound is at least one selected from the group consisting of sodium azide, potassium azide, and calcium azide.

18: The method of claim 11, further comprising:
preparing the 2,5-bis(4-carboxybiphenyl-4′-yl)oxazole of formula (III) by:
reacting the 2,5-bis(4-iodophenyl)oxazole in the presence of a second palladium salt and an arylboronic acid via a Suzuki cross-coupling reaction to produce a 2,5-bis(4-carboxybiphenyl methyl ester 4′-yl)oxazole of formula (VIII); 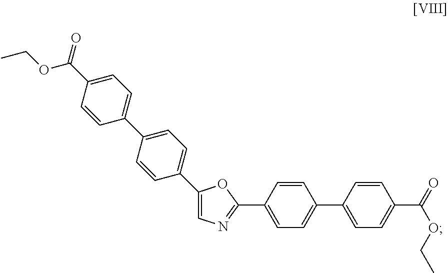 [SMILES: CCOC(=O)c1ccc(-c2ccc(-c3cnc(-c4ccc(-c5ccc(C(=O)OCC)cc5)cc4)o3)cc2)cc1]
and
hydrolyzing the 2,5-bis(4-carboxybiphenyl methyl ester 4′-yl)oxazole in the presence of a base at a temperature of about 50 to 90° C.

19: The method of claim 18, wherein the second palladium salt is palladium acetate having a palladium concentration of about 45 to 50 wt. % based on a total weight of the palladium acetate, and wherein the arylboronic acid is 4-ethoxycarbonylphenylboronic acid.

20: The method of claim 18, wherein the metal precursor comprises a zinc salt, and wherein the MOF has peaks with a 2 theta value of 5 to 6°, and 6.5 to 9.5°, as determined by powder X-ray diffraction (PXRD) spectrum.
